(19) United States
(12) Patent Application Publication
(10) Pub. No.: US 2016/0105642 A1
(43) Pub. Date: Apr. 14, 2016

(54) TRANSMISSION TERMINAL, TRANSMISSION SYSTEM, DISPLAY METHOD AND PROGRAM

(71) Applicants: Tatsuya NAGASE, Ohta-ku, Tokyo (JP); Yoshinaga KATO, Ohta-ku, Tokyo (JP)

(72) Inventors: Tatsuya NAGASE, Kanagawa (JP); Yoshinaga KATO, Kanagawa (JP)

(21) Appl. No.: 14/894,134

(22) PCT Filed: Jun. 4, 2014
(86) PCT No.: PCT/JP2014/065393

§ 371 Date: Nov. 25, 2015

(30) Foreign Application Priority Data
Jun. 6, 2013 (JP) 2013-120187
Apr. 4, 2014 (JP) 2014-078006

(51) Int. Cl. H04N 7/15; H04N 5/265

(52) U.S. Cl. CPC H04N 7/15; H04N 5/265

(57) ABSTRACT

A transmission terminal is for a communications connection with an other terminal via a network. The transmission terminal includes a reception unit that receives display data to be displayed on a display unit connected to the transmission terminal from the other terminal; a name acquisition unit that acquires a name associated with the other terminal from one or more names that are registered for the transmission terminal in advance; a name overlaying unit that generates overlaid display data by incorporating the acquired name in the display data; and an image display control unit that displays the overlaid display data on the display unit.

### TECHNICAL FIELD

The present invention relates to a transmission terminal or the like for a communications connection with an other terminal via a network.

### BACKGROUND ART

Recently, a transmission system to conduct a video conference between remote locations via a communication network, such as the Internet, has become popular. In such a transmission system, by sending and receiving image data and voice data between plural transmission terminals, the video conference is realized. Moreover, according to recent enhancements of the broadband environment, high-quality image data and voice data can be sent and received, understanding the status of the other party in the video conference becomes easier, and the fulfillment of communication by a video conference has been improved.

On a display unit of a terminal device, image data obtained by taking an image of the other party in the video conference are displayed. However, for a user of the terminal device, it is not always easy to determine from which terminal device the image data displayed on the display unit are sent out from other parties in the video conference. Patent Document 1, for example, discloses appending a name of the terminal of the transmission source or the like to the image data displayed on the display unit. Patent Document 1 discloses a video conference system wherein when images forwarded from plural terminal devices for a video conference are displayed as a multi-image, information on the corresponding terminal devices for the video conference are displayed in a part of a display region.

### CITATION LIST

### Patent Literature

Patent Document 1: Japanese Published Patent Application No. H09-238318.

### DISCLOSURE OF INVENTION

### Problem to be Solved by the Invention

However, in the video conference system as disclosed in Patent Document 1, an MCU (Multipoint Conferencing Unit) which is a terminal device of a chairperson, performs a process of displaying names of the respective terminal devices for the video conference of the images forwarded from the terminal device for the video conference, and sends to the plural terminal devices images for the video conference. That is, in the multi-image displayed on all the terminal devices participating in the video conference, correspondence between the terminal device for the video conference and the name of the terminal device is fixed. Accordingly, if any user desires to arbitrarily change the name of the terminal device for the video conference, the name cannot be changed.

In this way, in a video conference system of the related art, there is a problem that a name of a terminal device for the video conference cannot be changed for each user of the terminal devices for the video conference.

In view of the above subject matter, it is a general object of at least one embodiment of the present invention to provide a transmission terminal that substantially obviates one or more problems caused by the limitations and disadvantages of the related art.

### Means to be Solve the Problem

According to an aspect of the invention, a transmission terminal for a communications connection with an other terminal via a network includes a reception unit that receives display data to be displayed on a display unit connected to the transmission terminal from the other terminal; a name acquisition unit that acquires a name associated with the other terminal from one or more names that are registered for the transmission terminal in advance; a name overlaying unit that generates overlaid display data by incorporating the acquired name in the display data; and an image display control unit that displays the overlaid display data on the display unit.

According to another aspect of the invention, a program causes a transmission terminal for a communications connection with an other terminal via a network to perform a process of displaying display data. The process includes a reception step of receiving display data to be displayed on a display unit connected to the transmission terminal from the other terminal; a name acquisition step of acquiring a name associated with the other terminal from one or more names that are registered for the transmission terminal in advance; a name overlaying step of generating overlaid display data by incorporating the acquired name in the display data; and an image display control step of displaying the overlaid display data on the display unit.

According to yet another aspect of the invention, a display method of displaying display data by a transmission terminal for a communications connection with an other terminal via a network, includes a reception step of receiving display data to be displayed on a display unit connected to the transmission terminal from the other terminal; a name acquisition step of acquiring a name associated with the other terminal from one or more names that are registered for the transmission terminal in advance; a name overlaying step of generating overlaid display data by incorporating the acquired name in the display data; and an image display control step of displaying the overlaid display data on the display unit.

According to yet another aspect of the invention, a transmission system includes an information processing apparatus and a plurality of transmission terminals for a communications connection with the information processing apparatus via a network. In the information processing apparatus, one or more names for the transmission terminals are registered in advance. The transmission terminal includes a reception unit that receives display data to be displayed on a display unit connected to the transmission terminal from an other terminal; a name acquisition unit that acquires a name associated with the other terminal from the information processing apparatus; a name overlaying unit that generates overlaid display data by incorporating the acquired name in the display data; and an image display control unit that displays the overlaid display data on the display unit.

According to the present invention, a transmission terminal that can change information of each terminal of the other parties of the conference displayed is provided.

### BRIEF DESCRIPTION OF DRAWINGS

FIG. 1 is a diagram schematically illustrating an example of a whole configuration of a transmission system according to a present embodiment;

FIG. 2 is a diagram illustrating an example of a hardware configuration of a transmission terminal in the transmission system according to the present embodiment;

FIG. 3 is a diagram illustrating an example of a hardware configuration of a transmission management apparatus in the transmission system according to the present embodiment;

FIG. 4 is a functional block diagram illustrating an example of a transmission terminal, a relay apparatus, and the transmission management apparatus according to the present embodiment;

FIGS. 5A to 5C are explanatory diagrams for explaining image quality of image data according to the present embodiment;

FIG. 6 is a diagram illustrating an example of a table for managing change in quality according to the present embodiment;

FIG. 7 is a diagram illustrating an example of a table for managing the relay apparatus according to the present embodiment;

FIG. 8 is a diagram illustrating an example of a table for managing authentication for the terminal according to the present embodiment;

FIG. 9 is a diagram illustrating an example of a table for managing the terminal according to the present embodiment;

FIG. 10 is a diagram illustrating an example of a table for managing a destination list according to the present embodiment;

FIG. 11 is a diagram illustrating an example of a table for managing a session according to the present embodiment;

FIG. 12 is a diagram illustrating an example of a table for managing the image quality of the image data according to the present embodiment;

FIGS. 13A and 13B are diagrams illustrating an example of tables for managing names according to the present embodiment;

FIG. 14 is a diagram illustrating an example of a table for managing arrangement information according to the present embodiment;

FIG. 15 is a diagram illustrating an example of a table for managing images in a video conference according to the present embodiment;

FIG. 16 is a functional block diagram illustrating an example of an external input device according to the present embodiment;

FIG. 17 is a sequence diagram illustrating an example of a process for managing status information representing an operational status of each relay apparatus, sent from the relay apparatus to the transmission management apparatus according to the present embodiment;

FIG. 18 is a sequence diagram illustrating an example of a process in a stage of preparation for starting the communication between the transmission terminals according to the present embodiment;

FIG. 19 is a sequence diagram illustrating an example of a process of establishing a session in the transmission terminal according to the present embodiment;

FIG. 20 is a sequence diagram illustrating an example of a process of displaying the display data, displayed on the external input device, on a transmission terminal of an other party's terminal device in the conference according to the present embodiment;

FIG. 21 is a diagram illustrating an example of display data displayed on the display unit according to the present embodiment;

FIG. 22 is an explanatory diagram illustrating an example of screens displayed on the display units 216aa and 216db of the external input devices 40aa and 40db, respectively, in the whole configuration of the transmission system according to the present embodiment;

FIGS. 23A to 23C are diagrams illustrating an example of a desktop screen or the like displayed on the external input device according to the present embodiment;

FIGS. 24A to 24C are diagrams illustrating an example of each layout of the display screen according to the present embodiment;

FIG. 25 is a sequence diagram illustrating an example of a process of preparing the table for managing arrangement information by an arrangement information management table update unit according to the present, embodiment;

FIG. 26 is an explanatory diagram illustrating an example of a process of generating overlaid image data to which the name is appended according to the present embodiment;

FIGS. 27A and 27B are diagrams illustrating an example of a display screen displayed on the display unit of each of the transmission terminals according to the present embodiment;

FIG. 28 is a flowchart illustrating an example of a procedure of updating the name according to the present embodiment;

FIG. 29A is a table and FIG. 29B is a graphical representation illustrating another example of arrangement information according to the present embodiment;

FIG. 30 is a diagram illustrating an example of a system configuration in the case where the transmission terminal according to the present embodiment is applied to a car navigation device; and

FIG. 31 is a diagram illustrating an example of a configuration of the car navigation device according to the present embodiment.

### BEST MODE FOR CARRYING OUT THE INVENTION

### First Embodiment

Although the present invention has been described with reference to embodiments, the present invention is not limited to these embodiments, but various variations and modifications may be made without departing from the scope of the invention as set forth in the accompanying claims.

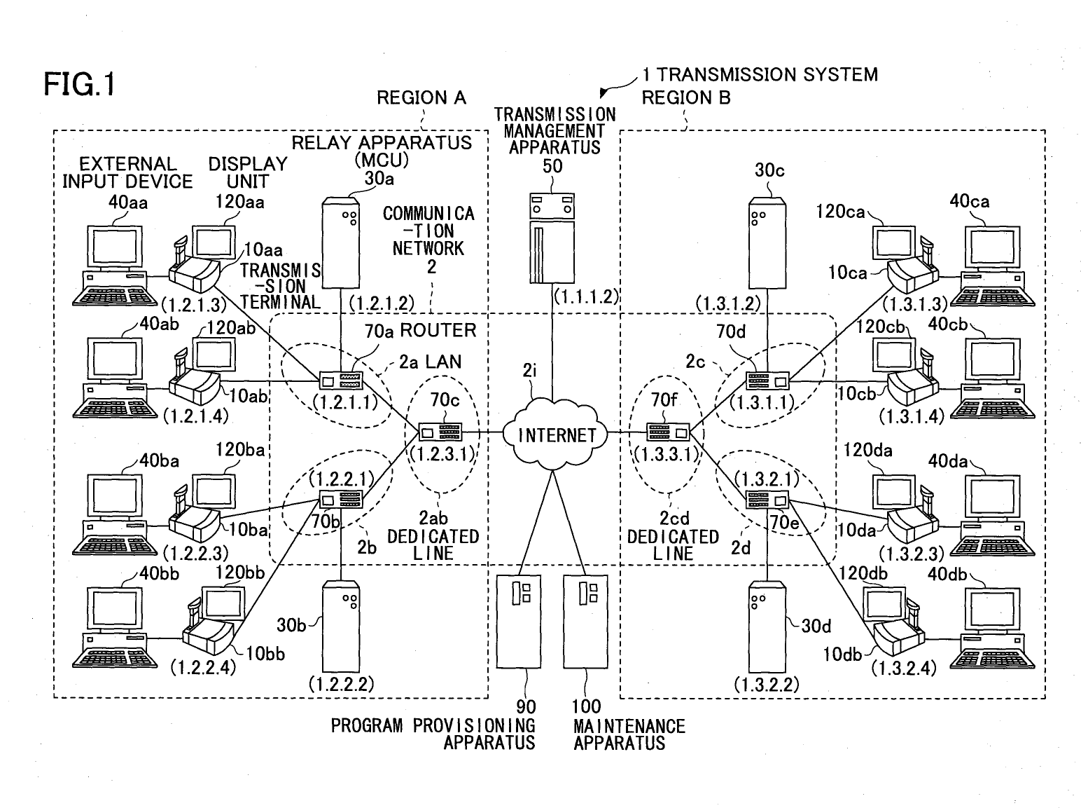

FIG. 1 is a diagram schematically illustrating a whole configuration of a transmission system 1 according to a present embodiment. In the following, with reference to FIG. 1, the transmission system 1 according to the present embodiment will be explained.

In general, a transmission system includes a data provisioning system in which content data are unidirectionally transmitted from one transmission terminal to the other terminal via the transmission management apparatus, or a communication system in which information, emotion or the like is transmitted mutually among plural transmission terminals via the transmission management apparatus. This communication system is a system that transmits information, emotion or the like among plural communication terminals (corresponding to “transmission terminals”) via a communication management system (corresponding to “transmission management apparatus”), and includes, for example, a TV conference system, a video conference system, a TV telephone system, an audio conference system, an audio telephone system, a PC (Personal computer) screen sharing system or the like.

In the present embodiment, a transmission system, a transmission management apparatus and a transmission terminal will be explained assuming that the present invention is applied to the TV conference system or the video conference system as an example of the communication system, applied to the TV conference management system or the video conference management system as an example of the communication management system and applied to the TV conference terminal or the video conference terminal as an example of the communication terminal. That is, the transmission terminal and the transmission management apparatus according to the present invention can be applied not only to the TV conference system or the video conference system, but also to the communication system or the transmission system.

The transmission system 1 according to the present embodiment (See FIG. 1) includes plural transmission terminals 10aa, 10ab, 10ba, 10bb, 10cb, 10da and 10db, plural display units 120aa, 120ab, 120ba, 120bb, 120ca, 120cb, 120da and 120db for the respective transmission terminals, plural external input devices 40aa, 40ab, 40ba, 40bb, 40ca, 40cb, 40da and 40db such as PCs connected to respective transmission terminals, plural relay apparatuses 30a, 30b, 30c and 30d, a transmission management apparatus 50, a program provisioning apparatus 90 and a maintenance apparatus 100.

In the following, unless otherwise stated, an arbitrary transmission terminal of the plural transmission terminals 10aa, . . . , 10db is denoted “transmission terminal 10”, an arbitrary display unit of the plural display units 120aa, . . . , 120db is denoted “display unit 120”, an arbitrary external input device of the plural external input devices 40aa, . . . , 40db is denoted “external input device 40”, and an arbitrary relay apparatus of the plural relay apparatuses 30aa, . . . , 30db is denoted “relay apparatus 30”. Moreover, the display unit 120 is an example of a display unit of the transmission terminal 10. Meanwhile, in FIG. 1, the transmission terminal 10 and the display unit 120 are separated, but the transmission terminal 10 and the display unit 120 may be integrated (the transmission terminal 10 incorporates the display unit 120). Moreover, in the case of the integrated configuration, the transmission terminal 10 may be provided with a function of a projector for projecting an image, thereby providing the same function as the display unit 120.

The transmission terminal 10 sends/receives image data, voice data, or the like to/from other terminals 10. In the present embodiment, the image data are video data. The image data may be still image data. Moreover, images of the image data may include both video and still images.

The relay apparatus 30 relays image data and voice data between the transmission terminals 10. The transmission management apparatus 50 manages the plural transmission terminals 10 and the plural relay apparatuses 30 in an integrated fashion.

The external input device 40 is connected to the transmission terminal 10, and sends display data for an image displayed on a display unit (a display unit 216, which will be explained later) of the external input device 40 to the transmission terminal 10. At least one of the display data and the image data are an example of data for display in claims.

Moreover, plural routers 70a, 70b, 70c, 70d, 70e and 70f, as shown in FIG. 1, select optimum paths on which the image data and voice data are sent/received. In the following explanation, unless otherwise stated, an arbitrary router of the plural router 70a, . . . , 70f is denoted “router 70”. The program provisioning apparatus 90 includes a hard disk (HD), which is not shown. The HD stores a program for the transmission terminal to realize various functions and various means in the transmission terminal 10, a program for the relay apparatus to realize various functions and various means in the relay apparatus, and a program for the transmission management to realize various functions and various means in the transmission management apparatus 50. The program provisioning apparatus 90 sends the program for the transmission terminal, the program for the relay apparatus and the program for the transmission management stored in the HD to the transmission terminal 10, the relay apparatus 30, and the transmission management apparatus 50, respectively.

Moreover, the transmission terminals 10aa and 10ab, the relay apparatus 30a, and the router 70a are connected with each other communicably via the LAN (Local Area Network) 2a, and the transmission terminals 10ba and 10bb, the relay apparatus 30b, and the router 70b are connected with each other communicably via the LAN 2b. The LAN 2a and the LAN 2b are connected with each other communicably via a dedicated line 2ab including the router 70c, and configured in a predetermined region A. For example, region A is Japan, the LAN 2a is configured in an office in Location K, and the LAN 2b is configured in an office in Location L.

On the other hand, the transmission terminals 10ca and 10cb, the relay apparatus 30c, and the router 70d connected with each other communicably via the LAN 2c, and the transmission terminals 10da and 10db, the relay apparatus 30d, and the router 70e are connected with each other communicably via the LAN 2d. The LAN 2c and the LAN 2d are connected with each other communicably via a, dedicated line 2cd including the router 70f, and configured in a predetermined region B. For example, region B is the United States of America, the LAN 2c is configured in an office in Location I, and the LAN 2d is configured in an office in Location J Region A and region B are communicably connected via the Internet 2i by the routers 70c and 70f, respectively.

Moreover, the transmission management apparatus 50, the program provisioning apparatus 90 and the maintenance apparatus 100 are communicably connected with the transmission terminal 10 and the relay apparatus 30 via the Internet 2i. The transmission management apparatus 50, the program provisioning apparatus 90 and the maintenance apparatus 100 may be installed in region A, in region B, or in an other region.

In the present embodiment, the communication network 2 is configured by the LAN 2a, the LAN 2b, the dedicated line 2ab, the Internet 2i, the dedicated line 2cb, the LAN 2c and the LAN 2d.

Moreover, a combination of four integers with parenthesis, indicated below each of the transmission terminals 10, the relay apparatus 30, the transmission management apparatus 50, the routers 70, the program provisioning apparatus 90, and the maintenance apparatus 100 in FIG. 1, represent an IP (Internet Protocol) address in a form of IPv4. For example, the IP address of the transmission terminal 10aa is “1.2.1.3”. Moreover, IPv6 may be adopted instead of IPv4, but IPv4 is employed for simplicity in the present embodiment.

<<Hardware Configuration>>

Next the hardware configuration according to the present embodiment will be explained.

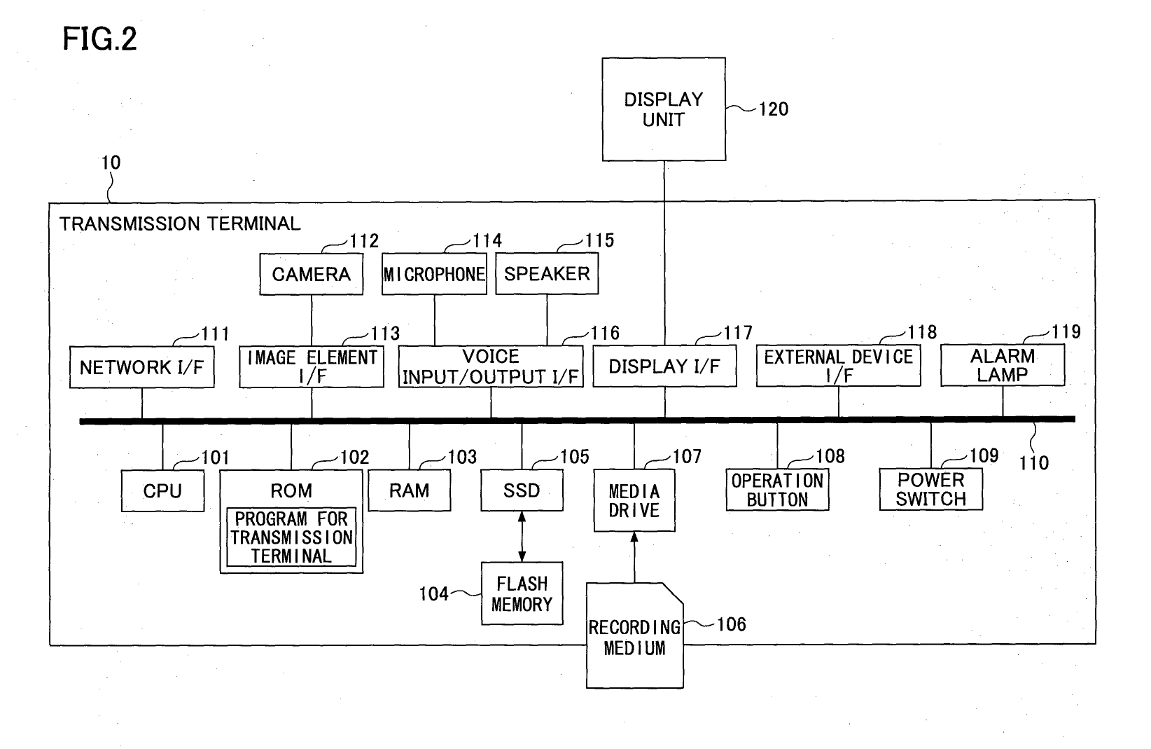

FIG. 2 is a diagram illustrating a hardware configuration of the transmission terminal 10 in the transmission system 1 according to the present embodiment. As shown in FIG. 2, the transmission terminal 10 includes a CPU (central processing unit) 101, which controls operations of the whole transmission terminal 10; a ROM (read-only memory) 102, which stores the program for the transmission terminal; a RAM (random access memory) 103, used as a work area for the CPU 101; a flash memory 104, storing a program for the terminal and various data, such as image data and voice data; an SSD (solid state drive) 105, which controls reading from and writing to the flash memory 104 the various data according to the control by the CPU 101; a media drive 107, which controls reading data from and writing (storing) data to a recording medium 106, such as a flash memory; an operation button 108, which is operated when switching a destination of the transmission terminal 10, or the like; a power switch 109, used for turning on or off the transmission terminal 10; and a network I/F (interface) 111 for transmitting data using the communication network 2. Moreover, the transmission terminal 10 further includes a camera 112, for acquiring image data by taking an image of an object according to control by the CPU 101; an image element I/F 113, which controls the driving of the camera 112; a microphone 114 for inputting voice (sound); a speaker 115 for outputting voice; a voice input/output I/F 116, which performs inputting/outputting processing for a voice signal between the microphone 114 and the speaker 115 according to the control by the CPU 101; a display I/F 117, which transmits image data to an external display unit 120 according to the control by the CPU 101; an external device I/F 118, for sending/receiving various data to/from external devices; an alarm lamp 119 for giving notice of a problem in the functions of the transmission terminal 10; and a bus line 110, such as an address bus or a data bus, which electrically connects the above components.

The recording medium 106 is detachable from the transmission terminal 10. Moreover, if the recording medium 106 is a non-volatile memory, from which data are read, or into which data are written according to the control by the CPU 101, not only the flash memory 104, but also EEPROM (electrically erasable and programmable ROM) may be used. Moreover, the camera 112 includes a solid image element, which converts light into an electric signal to obtain digital data for an image (picture) of an object. For the solid image element, for example, CCD (charge coupled device), CMOS (complementary metal oxide semiconductor), or the like is used. Furthermore, instead of the SSD 115, a hard disk drive (HDD) may be used.

The display unit 120 includes a display unit, formed of liquid crystal or organic EL (electro luminescence), which displays an image of the object or an icon image for operation.

Furthermore, the above-described program for the transmission terminal may be distributed as a file in an installable format or in an executable format stored in a recording medium readable by a computer, such as the recording medium 106.

Each of the camera 112, the microphone 114, and the speaker 115 may be an external device. The transmission terminal 10 may be provided as a dedicated device or may be, for example, a general-purpose PC (personal computer), a smartphone, a tablet-type terminal, a PDA (personal Data Assistant) or the like.

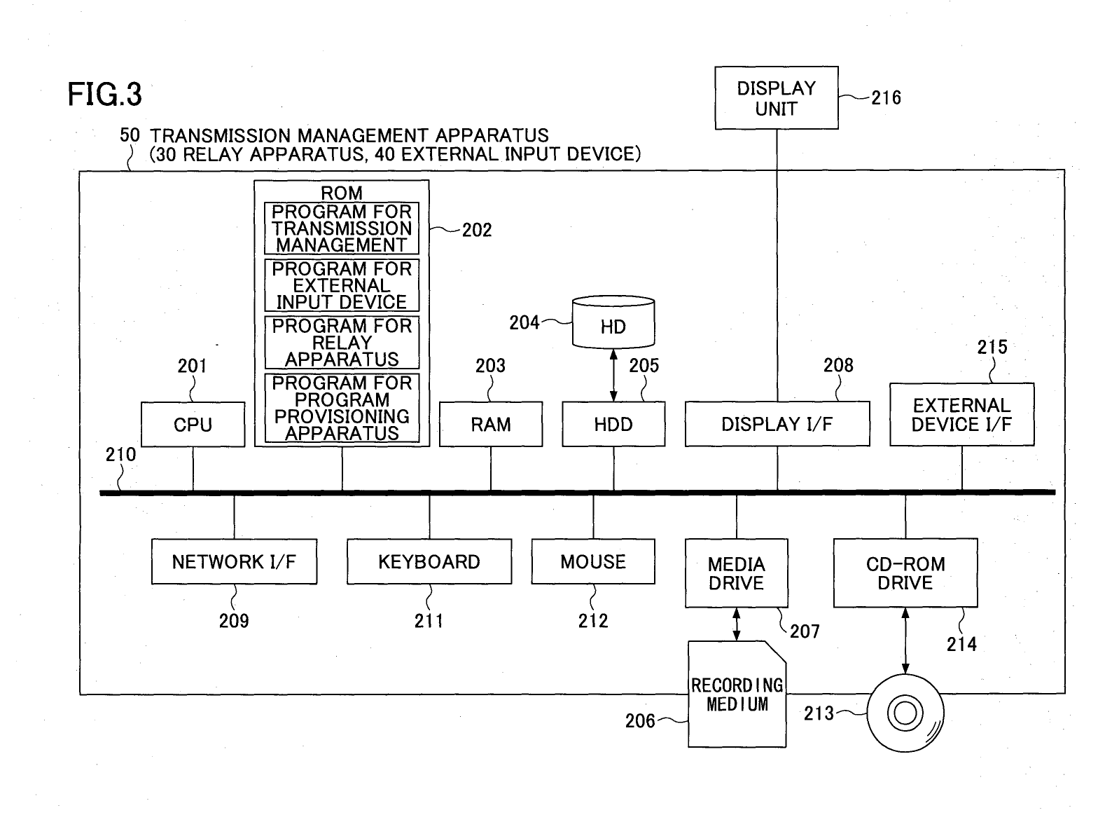

FIG. 3 is a diagram illustrating an example of a hardware configuration of the transmission management apparatus 50 in the transmission system 1 according to the present embodiment. The transmission management apparatus 50 includes a CPU 201, which controls operations of the whole transmission management apparatus 50; a ROM 202, which stores a program for transmission management; a RAM 203, used as a work area for the CPU 201; a HD (hard disk) 204, which stores various data; the HDD (hard disk drive) 205, which controls reading data from and writing data to the HD 204 according to control by the CPU 201; a media drive 207, which controls reading data from and writing (storing) data to a recording medium 206, such as a flash memory; a display I/F 208 for displaying on a display unit 216 various information items, such as a cursor, a menu, a window, a character or an image; a network I/F 209 for transmitting data using the communication network 2, which will be explained later; a keyboard 211 equipped with plural keys for inputting characters, numerical values, various instructions or the like; a mouse 212 for performing selection and execution of various instructions, selection of a processing object, a cursor movement, or the like; a CD-ROM drive 214, which controls reading various data from and writing various data to a CD-ROM (compact disc read only memory) 213, as an example of a detachable recording medium; an external device I/F, which sends/receives information items to/from an external device; and a bus line 210, such as an address bus or a data bus, which electrically connects the above components. The display unit 216 is also an example of the display unit of the external input device 40.

Moreover, the program for the transmission management may be distributed as a file in an installable format or in an executable format stored in a recording medium readable by a computer, such as the recording medium 206, the CD-ROM 213 or the like. The program for the transmission management may be stored in the HD 204.

Furthermore, since the external input device 40 has the same hardware configuration as the transmission management apparatus 50, an explanation will be omitted. However, a program for the external input device for controlling the external input device 40 is stored in the ROM 202. Also in this case, the program for the external input device may be distributed as a file in an installable format or in an executable format stored in a recording medium readable by a computer, such as the recording medium 206, the CD-ROM 213 or the like.

Moreover, since the relay apparatus 30 has the same hardware configuration as the transmission management apparatus 50, an explanation will be omitted. However, a program for a relay apparatus for controlling the relay apparatus 30 is stored in the ROM 202. Also in this case, the program for a relay apparatus may be distributed as a file in an installable format or in an executable format stored in a recording medium readable by a computer, such as the recording medium 206, the CD-ROM 213 or the like.

Moreover, since the program provisioning apparatus 90 has the same hardware configuration as the transmission management apparatus 50, an explanation will be omitted. However, a program for a program provisioning apparatus for controlling the program provisioning apparatus 90 is stored in the ROM 202. Also in this case, the program for the relay apparatus may be distributed as a file in an installable format or in an executable format stored in a recording medium readable by a computer, such as the recording medium 206, the CD-ROM 213 or the like. The program for the program provisioning apparatus may be stored in the HD 204, other than the ROM 202.

Furthermore, since the maintenance apparatus 100 has the same hardware configuration as the transmission management apparatus 50, an explanation will be omitted. The maintenance apparatus 100 is a computer which keeps, maintains or manages at least one of the transmission terminal 10, the relay apparatus 30, the transmission management apparatus 50 or the program provisioning apparatus 90. For example, in the case that the maintenance apparatus 100 is installed in one country and the transmission terminal 10, the relay apparatus 30, the transmission management apparatus 50 or the program provisioning apparatus 90 is installed in an other country, the maintenance apparatus 100 performs the maintenance process of keeping, managing, maintaining, or the like, for at least one of the transmission terminal 10, the relay apparatus 30, the transmission management apparatus 50 or the program provisioning apparatus 90, remotely via the communication network 2.

Moreover, the maintenance apparatus 100 performs a maintenance process of managing a model number, a production number, a sales destination, maintenance and inspection, a failure history or the like, for at least one of the transmission terminal 10, the relay apparatus 30, the transmission management apparatus 50, or the program provisioning apparatus 90, without using the communication network 2.

As an other example of the detachable recording medium, the program may be distributed as a file stored in a recording medium readable by a computer, such as a CD-R (compact disc recordable), a DVD (digital versatile disk), a Blu-ray disc, or the like.

<<Functional Configuration According to Embodiment>>

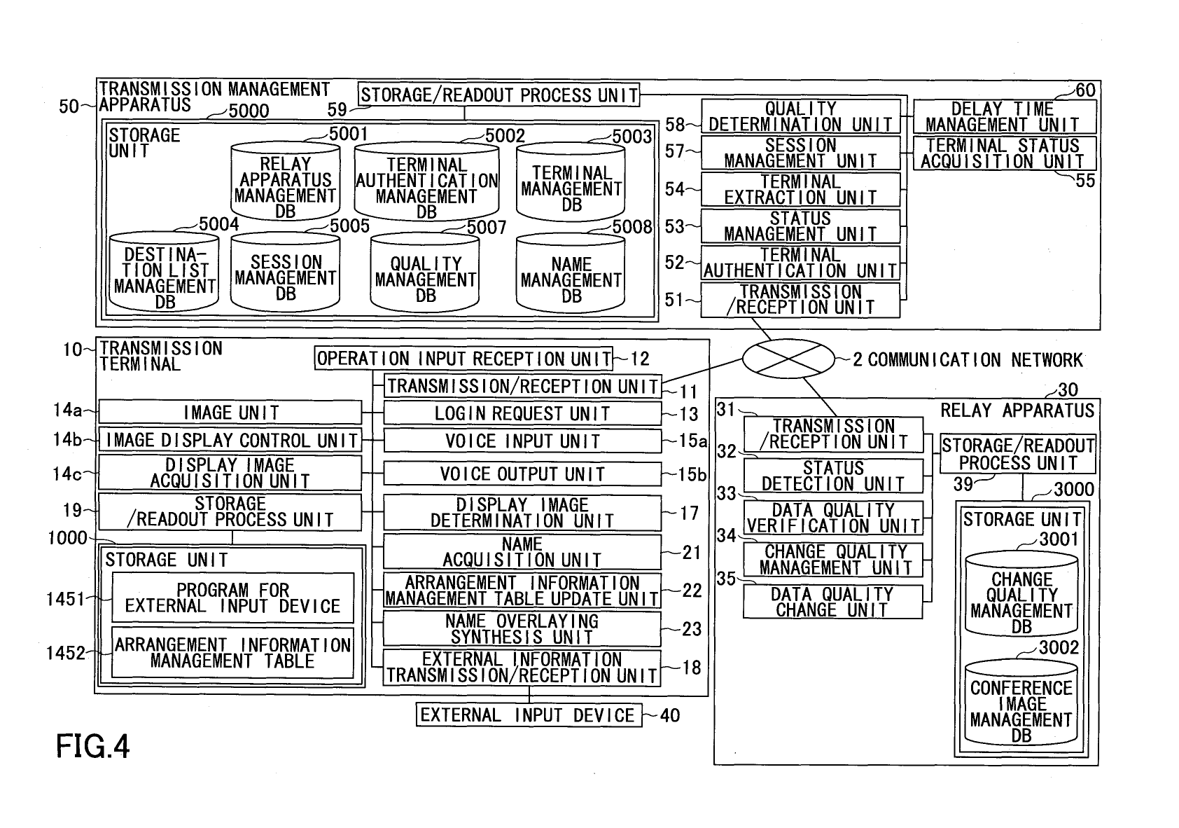

Next, the functional configuration according to the present embodiment will be explained with reference to FIGS. 4 to 16. FIG. 4 is a functional block diagram illustrating an example of the transmission system according to the present embodiment. The transmission system 1 includes the transmission terminal 10, the relay apparatus 30 and the transmission management apparatus 50. In the example shown in FIG. 4, the transmission terminal 10, the relay apparatus 30 and the transmission management apparatus 50 are connected so as to perform data communications via the communication network 2. Moreover, the external input device 40 is connected so as to send/receive data to/from the transmission terminal 10. The program provisioning apparatus 90 and the maintenance apparatus 100, shown in FIG. 1, are not relevant to the communication for the video conference directly, and are omitted in FIG. 4.

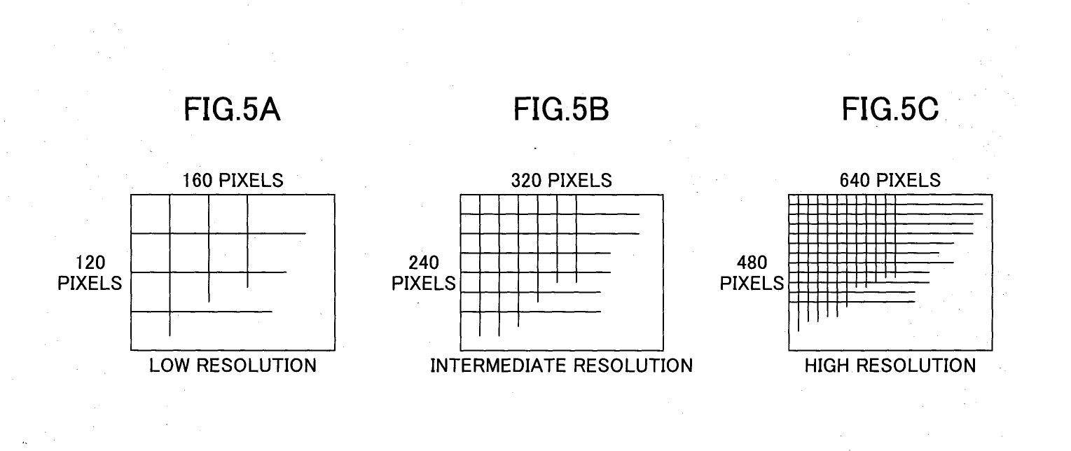

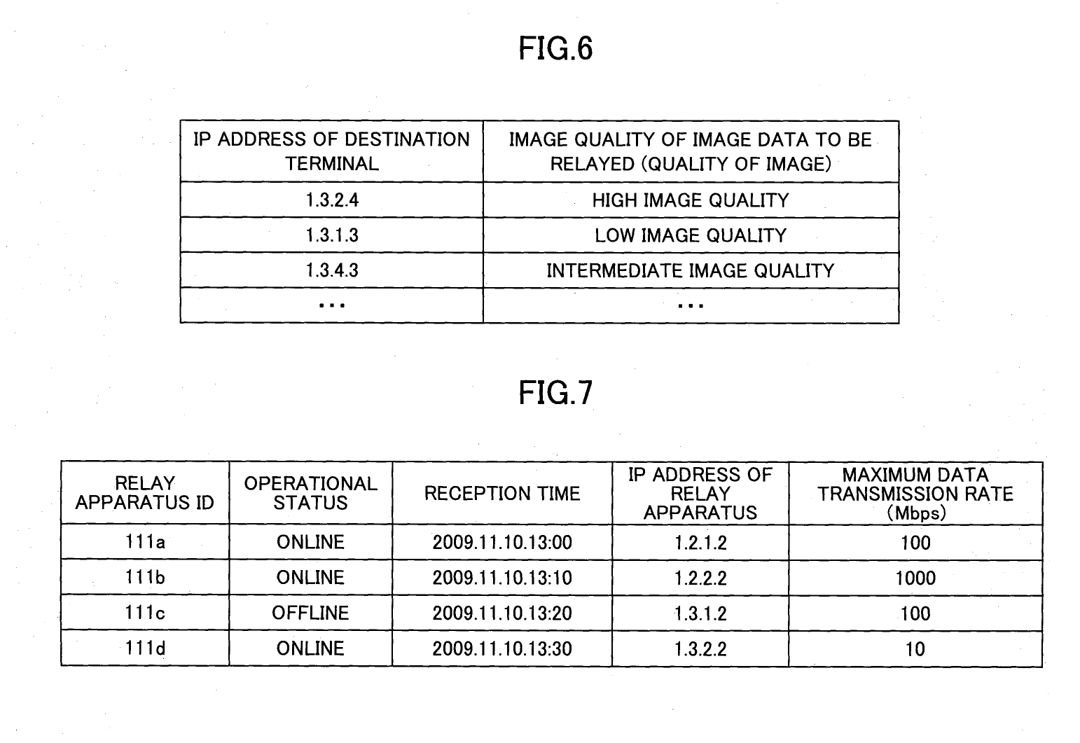

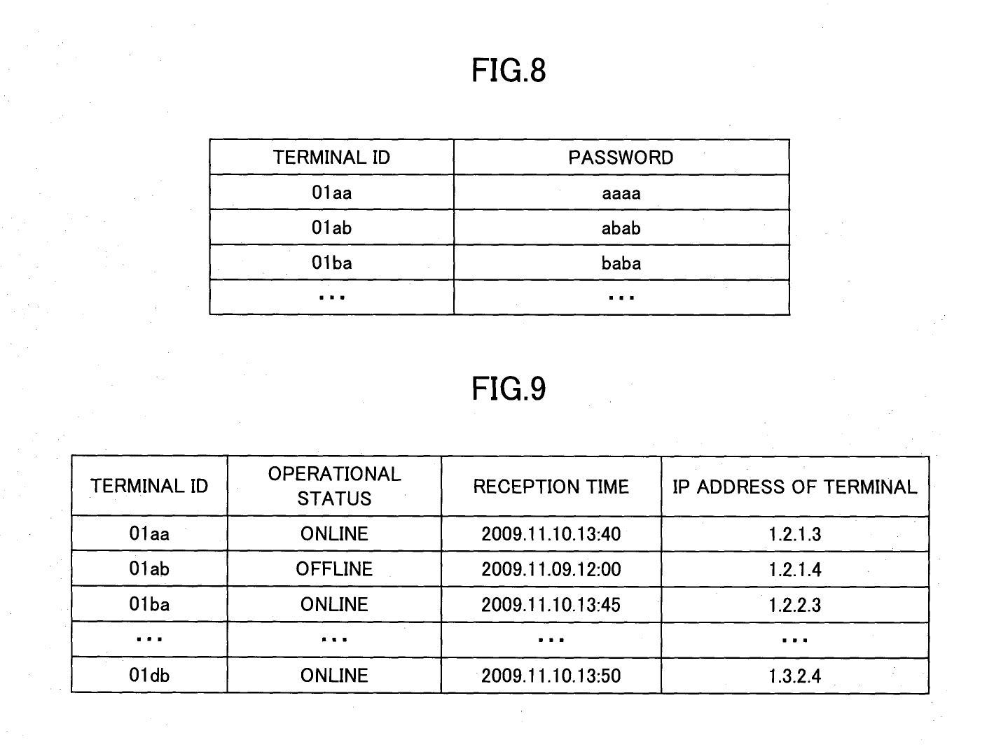

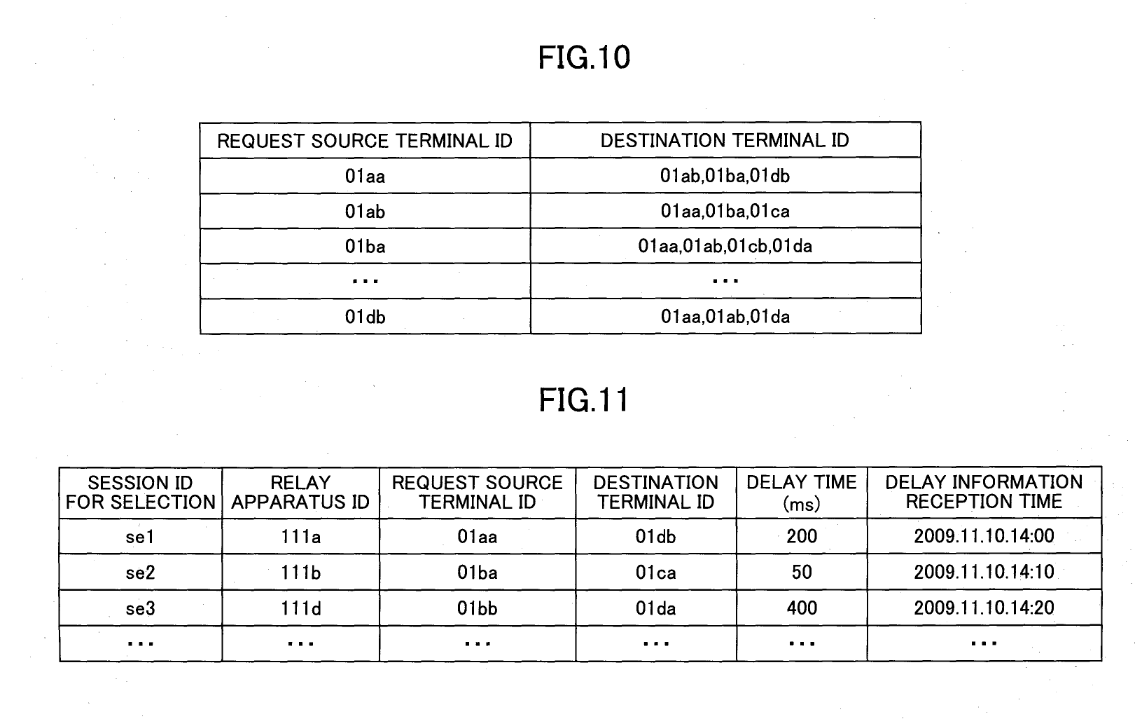

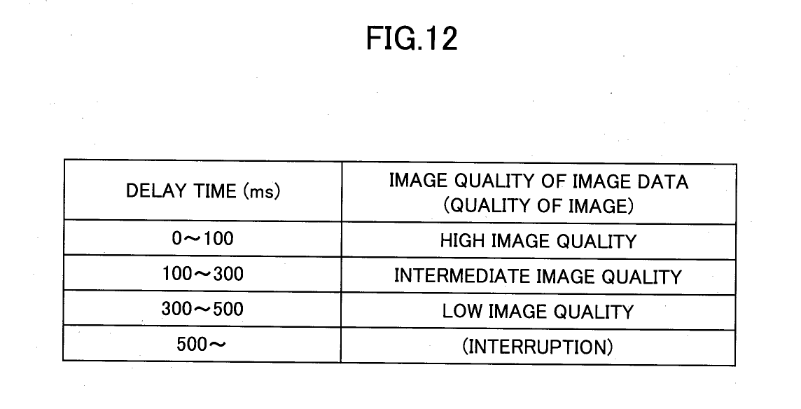

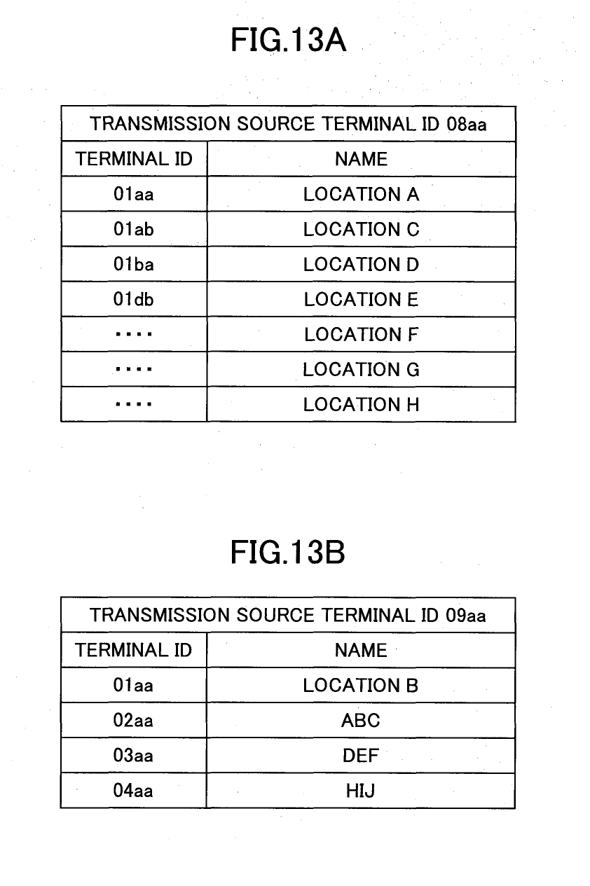

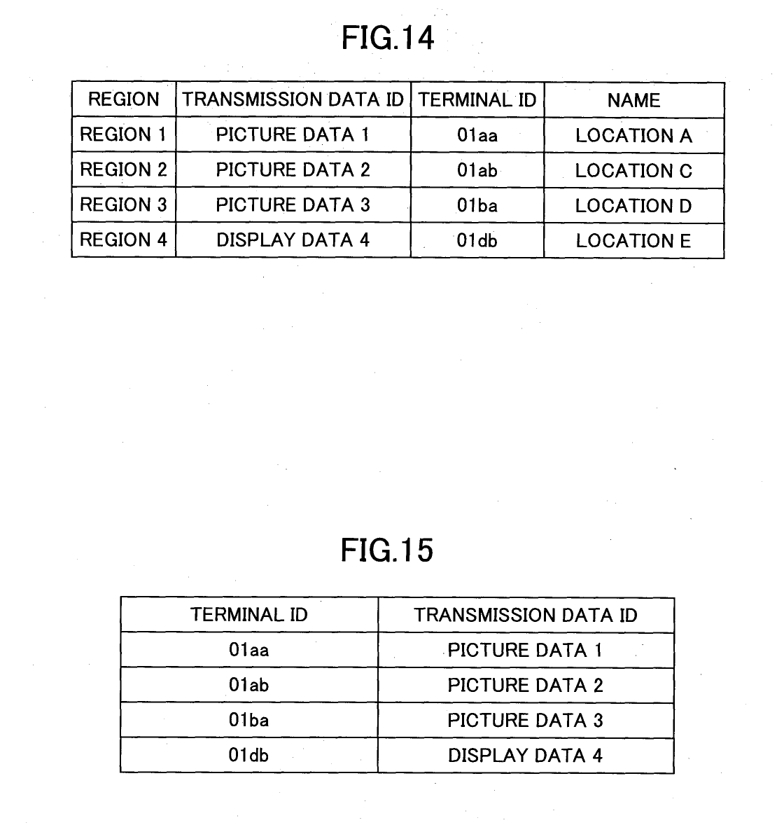

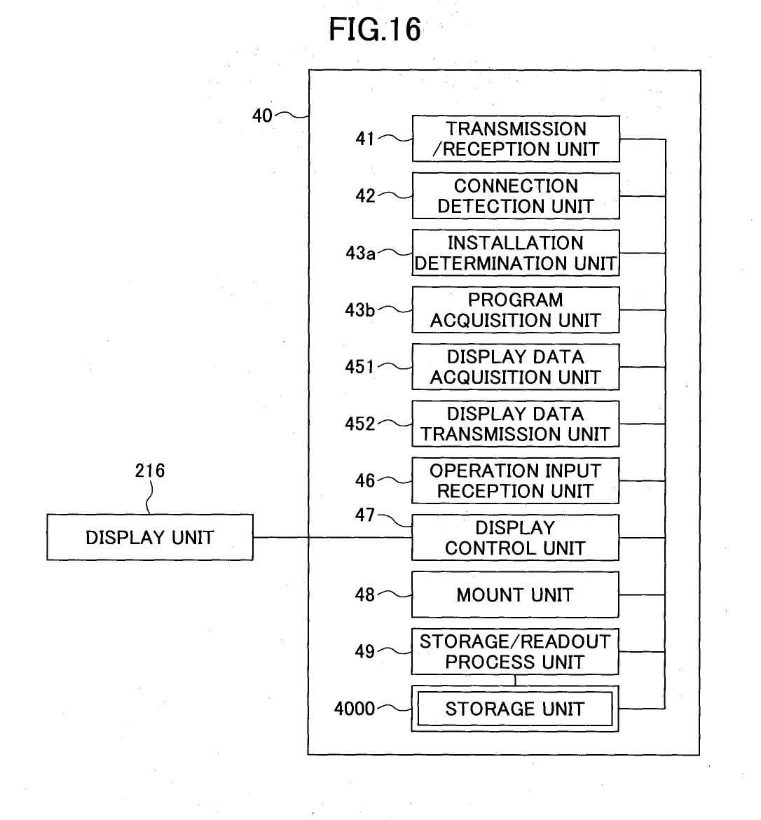

FIGS. 5A to 5C are explanatory diagrams for explaining image quality of image data. FIG. 6 is a diagram illustrating an example of a table for managing change in quality of image data. FIG. 7 is a diagram illustrating an example of a table for managing the relay apparatus. FIG. 8 is a diagram illustrating an example of a table for managing authentication for the terminal. FIG. 9 is a diagram illustrating an example of a table for managing the terminal. FIG. 10 is a diagram illustrating an example of a table for managing a destination list. FIG. 11 is a diagram illustrating an example of a table for managing a session. FIG. 12 is a diagram illustrating an example of a table for managing the image quality of the image data. Moreover, FIGS. 13A and 13B are diagrams illustrating an example of tables for managing names. FIG. 14 is a diagram illustrating an example of a table for managing arrangement information. FIG. 15 is a diagram illustrating an example of a table for managing images in video conference. FIG. 16 is a functional block diagram illustrating an example of an external input device 40.

<Functional Configuration of Transmission Terminal>

The transmission terminal 10, as shown in FIG. 4, includes a transmission/reception unit 11; an operation input reception unit 12; a login request unit 13, an image unit 14a, an image display control unit 14b, a display image acquisition unit 14c, a voice input unit 15a, a voice output unit 15b, a display image determination unit 17, a name acquisition unit 21, an arrangement information management table update unit 22, a name overlaying unit 23, an external information transmission/reception unit 18, a storage/readout process unit 19. Each of the above units is a function or a functioning means realized by one of the components, shown in FIG. 2, operating according to an instruction from the CPU 101 following the program stored in the ROM 102. Moreover, the transmission terminal 10 includes a storage unit 1000, including the SSD 105, shown in FIG. 2.

<<Arrangement Information Management Table>>

The storage unit 1000 stores an arrangement information management table 1452 as shown in FIG. 14. The arrangement information management table, which is an example of “a region management table” in claims, is a table that associates respective regions of the display unit 120 of each of the transmission terminals with transmission data IDs. The transmission data ID is an example of “data identification information” in claims. Identification information of the region is registered in the field of “region”. Identification information of data transmitted from the relay apparatus including a type of image data or display data is registered in the field of “transmission data ID”. A terminal ID of a transmission terminal that sends the image data or the display data, which is an example of terminal identification information in claims, is registered in the field of “terminal ID”. In the field of “name”, a name associated with a terminal ID in the name management table is registered.

The arrangement information management table is generated at the time of starting a conference. The table is, afterward, updated when the layout of the display screen is changed (the image data or the display data assigned to the region are changed or a transmission terminal which participates in the conference or leaves the conference arises).

<Each Functional Element of Transmission Terminal>

Next, each of the functional elements of the transmission terminal 10 will be explained in detail. The transmission/reception unit 11 is realized by the network I/F 111, shown in FIG. 2, and sends various data to and receives various data from other terminals 10, the relay apparatus 30 or the transmission management apparatus 50 via the communication network 2. The operation input reception unit 12 is realized by the operation button 108 and the power switch 109, shown in FIG. 2, and receives various inputs from a user. For example, when the user turns the power switch of a main body of the transmission terminal 10 to ON, the operation input reception unit 12 (See FIG. 4) receives a signal of the user's operation, and turns on the power.

The login request unit 13 is realized by the instruction from the CPU 101, shown in FIG. 2, and when receiving the operation for turning on the power, automatically sends login request information for requiring a login and an IP address of the transmission terminal 10 at the time of sending, from the transmission/reception unit 11 to the transmission management apparatus 50 via the communication network 2.

The image unit 14a is realized by the camera 112 and the image element I/F 113, shown in FIG. 2, and generates image data for an image of an object obtained by taking an image of the object. The image display control unit 14b is realized by the display I/F, shown in FIG. 2, and performs a rendering process for image data, to control the image data so as to display the image represented by the image data on the display unit 120. The display image acquisition unit 14c acquires image data which represents the image displayed on the display unit 120. In the present embodiment, data representing an image taken by the camera 112 is denoted as “image data”. Moreover, data representing an image displayed on the display unit 216 of the external input unit 40, which will be explained later in detail, is denoted as “display data”. The image data and the display data are, for example, in the format of JPEG (Joint Photographic Experts Group), Bitmap, GDI (Graphics Device Interface) or the like.

The voice input unit 15a realized by the microphone 114 and the voice input/output I/F 116, shown in FIG. 2, inputs the user's voice, converts the voice into a voice signal, and outputs voice data regarding the voice signal. The voice output unit 15b realized by the speaker 115 and the voice input/output I/F 116, converts the voice signal regarding the voice data into a sound, and outputs the sound.

Moreover, the external information transmission/reception unit 18 sends/receives data to/from the external input device via the external device I/F, shown in FIG. 2.

Moreover, the storage/readout process unit 19 is executed by the SSD 105, shown in FIG. 2, which stores various data into the storage unit 1000, and reads out various data stored in the storage unit 1000.

The display image determination unit 17 determines image data to be displayed on the display unit 120. Moreover, when the screen is divided into plural regions, the display image determination unit 17 determines transmission terminals, image data of which are displayed in the respective regions.

The name acquisition unit 21 acquires the whole of or a part of the name management table from the transmission management apparatus 50. The name management table is registered in the transmission management apparatus 50 by the user in advance.

The arrangement information management table update unit 22 generates an arrangement information management table from a start-up of the transmission terminal 10 until a start of a conference. When a layout is changed and the arrangement information management table is required to be updated, the arrangement information management table update unit 22 updates the arrangement information management table.

The name overlaying unit 23 generates overlaid image data from image data displayed on the region and a name read out from the arrangement information management table.

The storage unit 1000 stores a terminal ID (Identification) for identifying the transmission terminal 10, password, a relay apparatus ID for identifying a relay apparatus 30 which sends image data, voice data and various data, and an IP address of a destination terminal or the like, which are not shown. Moreover, the storage unit 1000 stores a program for the external input device 1451 and an arrangement information management table 1452.

By installing the program for the external input device 1451 sent from the storage unit 1000 in the external input device 40, the external input device 40 is provided with respective functions which will be described in the section of <respective functional parts of external input device> referring to FIG. 16 in detail.

Moreover, the terminal ID and the relay apparatus ID, which will be explained later, according to the present embodiment, are identification information, such as a language, a character, a symbol, numerical signs, or the like, used for uniquely identifying the transmission terminal 10 and the relay apparatus 30, respectively. Moreover, the terminal ID and the relay apparatus ID may be a combination of at least two of the language, the character, the symbol, or the numerical signs. In the following explanation, the transmission terminal 10 which is a request source requesting the start of the video conference is denoted “request source terminal”, and the transmission terminal 10 which is a destination of the request is denoted “destination terminal”.

<Functional Configuration of Relay Apparatus>

Next, the function or means of the relay apparatus 30 will be explained in the following. The relay apparatus 30 includes a transmission/reception unit 31, a status detection unit 32, a data quality verification unit 33, a change quality management unit 34, a data quality change unit 35, and a storage/readout process unit 39. Each of the above units is a function or a means realized by one of the components, shown in FIG. 3, operating according to an instruction from the CPU 201 following the program stored in the ROM 202. Moreover, the relay apparatus 30 includes a storage unit 3000, which includes a storage unit 3000 configured by one of the ROM 202, RAM 203 and the HDD 205.

<<Change Quality Management Table>>

The storage unit 3000 includes a change quality management DB 3001, configured by a change quality management table, as shown in FIG. 6. The change quality management table manages an IP address of a transmission terminal 10, to which image data are relayed, and a quality of the image data, to be relayed to the transmission terminal 10 by the relay apparatus, which are associated with each other.

The resolution of an image represented by image data, processed in the transmission system 1 according to the present embodiment, will be explained in the following. FIG. 5A illustrates an example of an image with a low resolution, as a base image, having 160 pixels in the horizontal direction and 120 pixels in the vertical direction. FIG. 5B illustrates an example of an image with an intermediate resolution, having 320 pixels in the horizontal direction and 240 pixels in the vertical direction. FIG. 5C illustrates an example of an image with a high resolution, having 640 pixels in the horizontal direction and 480 pixels in the vertical direction. In the case of communication through a narrow bandwidth path, image data of low image quality including only image data of low resolution as a base image are relayed. In the case where the bandwidth is relatively broad, image data of intermediate quality including image data of the low resolution as a base image and image data of the intermediate resolution are relayed. In the case where the bandwidth is quite broad, image data of high image quality including image data of the low resolution as a base image, image data of the intermediate resolution and image data of the high resolution are relayed. For example, FIG. 6 shows that according to the change quality management table, the relay apparatus 30 relays to the destination terminal 10db (see FIG. 1) with the IP address (1.3.2.4) image data of “high image quality”.

<<Conference Image Management Table>>

In the storage unit 3000, a conference image management DB 3002 is configured including a conference image management table, as shown in FIG. 15. With reference to FIG. 15, in the conference image management table, terminal ID and transmission data ID are registered and associated with each other. In the conference image management table, it is registered which image data or which display data each of the transmission terminals sends in each of the conferences. By the conference image management table or the like, data delivered to each of the transmission terminals by the relay apparatus are identified, for example, image data 1 to the transmission terminal 01aa, display data 4 to the transmission terminal 01db, or the like.

Since each of the transmission terminals 10 sends image data or display data with the IP address as the identification information of the self-location in the Internet, the terminal ID is not included. Moreover, the relay apparatus appends the transmission data ID to the image data or the display data and delivers the image data or the display data to each of the transmission terminals. Accordingly, the terminal ID can be connected to the transmission data ID by the conference image management table, and the image data or the display data can be associated with a name.

<Each Functional Element of the Relay Apparatus>

Next, each functional element of the relay apparatus 30 will be explained in detail. In the following, in the explanation of the functional element of the relay apparatus 30, a relationship between the functional element and the component, shown in FIG. 3, which realizes the functional element of the relay apparatus 30, will be described.

The transmission/reception unit 31 (see FIG. 4) of the relay apparatus 30 is realized by the network I/F 209, shown in FIG. 3, and sends various data to and receives various data from the transmission terminals 10, the other relay apparatus 30 and the transmission management apparatus 50, via the communication network 2. The status detection unit 32 is realized by the instruction from the CPU 201, shown in FIG. 3, and detects an operational status of the relay apparatus 30, which includes the status detection unit 32. The operational status is, for example, “online” or “offline”.

The data quality verification unit 33 is realized by the instruction from the CPU 201, shown in FIG. 3, and searches the change quality management table (see FIG. 6) utilizing the IP address of the destination terminal 10 as a search key, extracts image quality of the image data relayed to the destination terminal with the IP address, and verifies the image quality of the image data to be relayed. The change quality management unit 34 is realized by the instruction from the CPU 201, shown in FIG. 3, changes content in the change quality management DB 3001, based on quality information, which will be described later, transmitted from the transmission management apparatus 50. For example, in the case that during the request source terminal 10aa with the terminal ID “01aa” communicates with the destination terminal 10db with the terminal ID “01db” in the video conference by sending/receiving image data of high image quality, the request source terminal 10bb and the destination terminal 10ca start another video conference via the communication network 2, and a delay occurs in receiving image data at the destination terminal 10db, the relay apparatus 30 is required to lower the image quality of the image data, which has been relayed, to the intermediate image quality. In such a case, the content in the change quality management DB 3001 is updated so as to lower the image quality of image data relayed by the relay apparatus 30 from the high image quality to the low image quality, based on the quality information for the intermediate image quality.

The data quality change unit 35 is realized by the instruction from the CPU 201, shown in FIG. 3, and changes the image quality of the image data sent from the request source terminal 10 based on the content in the updated change quality management DB 3001. The storage/readout process unit 39 is realized by the instruction from the CPU 201, stores various data into the storage unit 3000, and reads out various data from the storage unit 3000.

<Functional Configuration of the Transmission Management Apparatus>

Next, the functions of the transmission management apparatus 50 will be explained in the following. The transmission management apparatus 50 includes, as shown in FIG. 4, a transmission/reception unit 51, a terminal authentication unit 52, a status management unit 53, a terminal extraction unit 54, a terminal status acquisition unit 55, a session management unit 57, a quality determination unit 58, a storage/readout process unit 59, and a delay time management unit 60. Each of the above units is a function realized by one of the components shown in FIG. 3, operating according to an instruction from the CPU 201 following the program stored in the ROM 202. Moreover, the transmission management apparatus 50 includes a storage unit 5000, configured by one of the ROM 202, the RAM 203, and the HDD 205.

<<Relay Apparatus Management Table>>

The storage unit 5000 includes a relay apparatus management DB 5001, including a relay apparatus management table, as shown in FIG. 7. The relay apparatus management table manages an operational status of the relay apparatus 30, a reception time when the transmission management apparatus 50 receives status information indicating the operational status, an IP address, of the relay apparatus 30, and the maximum data transmission rate (Mbps) at the relay apparatus 30, which are associated with each other, for each relay apparatus ID of the relay apparatus 30. For example, the relay apparatus management table, shown in FIG. 7, indicates that the relay apparatus 30a with the relay apparatus ID “111a” (see FIG. 1), is in the operational status “online”, the status information is received by the transmission management apparatus 50 on “Nov. 10, 2009, 13:00”, the IP address of the relay apparatus 30a is “1.2.1.2”, and the maximum data transmission rate of the relay apparatus 30a is 100 Mbps.

<<Terminal Authentication Management Table>>

Moreover, the storage unit 5000 includes a terminal authentication management DB 5002, including a terminal authentication managing table, as shown in FIG. 8. In the terminal authentication management table, each terminal ID of all the transmission terminals 10 managed by the transmission management apparatus 50 is associated with a password for the terminal ID. For example, the terminal authentication management table, as shown in FIG. 8, indicates that a terminal ID of the transmission terminal 10aa (see FIG. 1) is “01aa” and a password is “aaaa”.

<<Terminal Management Table>>

Moreover, the storage unit 5000 includes a terminal management database (DB) 5003, including a terminal management table, as shown in FIG. 9. The terminal management table manages, for each terminal ID of the transmission terminals 10, an operational status of the transmission terminal 10, a reception time when the transmission management apparatus 50 receives login request information, which will be explained later, and an IP address of the transmission terminal 10, which are associated with each other. For example, the terminal management table, as shown in FIG. 9, indicates that the transmission terminal 10aa with the terminal ID “01aa” (see FIG. 1), is in the operational states “online”, the transmission management apparatus 50 receives the login request information at “Nov. 10, 2009, 13:40” and the IP address of the transmission terminal 10aa is “1.2.1.3”.

<<Destination List Management Table>>

Moreover, the storage unit 5000 includes a destination list management DB 5004, including a destination list management table, as shown in FIG. 10. The destination list management table manages request source terminals 10, which require starting communications in the video conference, so that all terminal IDs of destination terminals 10 registered as candidates of a destination terminal 10 are associated with each of the terminal IDs of the request source terminals 10. For example, the destination list management table, shown in FIG. 10, indicates that the candidates of a destination terminal 10, with which the request source terminal 10aa with the terminal ID “01aa” (see FIG. 1) requires to start communication in the video conference, are three transmission terminals, i.e. the transmission terminal 10ab with the terminal ID “01ab”, the transmission terminal 10ba with the terminal ID “01ba” and the transmission terminal 10db with the terminal ID “10db”. The candidate of the destination terminal 10 may be updated by appending or deleting an item in the destination list management table according to a request from the request source terminal 10 to the transmission management apparatus 50.

<<Session Management Table>>

Moreover, the storage unit 5000 includes a session management DB 5005, including a session management table, as shown in FIG. 11. The session management table manages, for each of the session IDs for selection used for executing a session to select the relay apparatus 30, a relay apparatus ID of the relay apparatus 30, a terminal ID of the request source terminal 10, a terminal ID of the destination terminal 10, a delay time (ms), and a reception time, which are associated with each other. The delay time (ms) in this table is a delay time of reception in receiving image data at the destination terminal 10. The reception time is when the transmission management apparatus 50 receives delay information from the destination terminal 10 which indicates the delay time.

For example, the session management table, shown in FIG. 11, indicates that the relay apparatus 30a (with the relay device ID “111a”), selected in a session executed using the session ID for selection “se1”, relays image data and voice data between the request source terminal 10aa (with the terminal ID “01aa”) and the destination terminal 10db (with the terminal ID “01db”). The session management table further indicates that the delay time of image data at the destination terminal 10db at the time of “Nov. 10, 2009, 14:00” is 200 ms.

In the case of conducting the video conference between two transmission terminals 10, the reception time of the delay information may be managed based on the delay information sent from the request source terminal 10, not from the destination terminal 10. However, in the video conference among three or more transmission terminals 10, the reception time of the delay information is managed based on the delay information sent from the transmission terminal 10, which receives image data and voice data.

<<Quality Management Table>>

Furthermore, the storage unit 5000 includes a quality management DB 5007, including a quality management table, as shown in FIG. 12. The quality management table manages the delay time (ms) of image data at the request source terminal 10 or the destination terminal 10, and image quality of the image data to be relayed at the relay apparatus 30, which are associated with each other.

<<Name Management Table>>

Moreover, the storage unit 5000 includes a name management DB 5008, including a name management table, as shown in FIG. 13. The name management table is an example of a name database recited in claims. With reference to FIGS. 13A and 13B, in the name management table, the respective terminal IDs are associated with names. The name management table is sent from each of the transmission terminals 10 to the transmission management apparatus 50 with the terminal ID. In the name management DB, the name management table is managed associated with the terminal ID of the transmission terminal 10 as the transmission source. The name management table may be registered to the name management DB 5008 from a PC operated by a system administrator or the like.

The name management table manages the terminal ID, registered to the destination list management table for each of the transmission terminals, associated with the name of the transmission terminal. Since the destination list management table is registered in the transmission management apparatus 50, and may be updated, the name management table is also preferably included in the transmission management apparatus 50.

However, the name may not only be associated with the terminal ID, which is registered in the destination list management table, but also with an arbitrary terminal ID. In this case, the transmission terminal may include the name management table.

The name may be freely set by a user. For example, the user operates the operation button 108 of the transmission terminal, to input the name associated with each of the terminal IDs. The user knows which location the transmission terminal is located at (which location the terminal ID is associated with).

The name management table is a table dedicated for a transmission terminal, which is configured for each of the transmission terminals. Accordingly, the registered names may be different (or may be the same) even for the same terminal ID depending on the transmission terminal of the transmission source. For example, to the transmission terminal having the terminal ID of the transmission source of 08aa, the name “Location A” is assigned as the name of the terminal ID of 01aa. But, to the transmission terminal having the terminal ID of the transmission source of 09aa, the name “Location B” is assigned as the name of the terminal ID of 01aa. On the other hand, a name management table may be commonly referred by plural transmission terminals.

Meanwhile, in FIGS. 13A and 13B, a terminal ID and a name of the self-location are not registered. A user may select whether to register the terminal ID and the name of the self-location. In the case where the name of the self-location is not registered, the transmission terminal may be displayed “self-location”, for example, or may not be displayed.

<Each Functional Element in Transmission Management Apparatus>

Next, each function element in the transmission management apparatus 50 will be explained in detail. In the following, in the explanation of the functional element of the transmission management apparatus 50, a relationship between the functional element and the component, shown in FIG. 3, which realizes the functional element of the transmission management apparatus 50, will be also described.

The transmission/reception unit 51 (see FIG. 4) is executed by the network I/F 209, and sends various data to and receives various data from the transmission terminal 10, the relay apparatus 30 or other system (the program provisioning apparatus 90, or the maintenance apparatus 100) via the communication network 2. The terminal authentication unit 52 searches the terminal authentication management DB 5002 in the storage unit 5000 with a terminal ID and a password used as a search key which is included in the login request information received via the transmission/reception unit 51, and determines whether the same terminal ID and the same password are managed in the terminal authentication management DB 5002, in order to perform the terminal authentication. The status management unit 53, in order to manage the operational status of the request source terminal 10, which requires a login, manages the terminal ID of the request source terminal 10, the operational status of the request source terminal 10, the reception time when the transmission management apparatus 50 receives the login request information, and the IP address of the request source terminal 10, by associating them with each other and then storing them in the terminal management table (see FIG. 9).

The terminal extraction unit 54 extracts a terminal ID by searching the destination list management table (see FIG. 10) with the terminal ID of the request source terminal 10 as a search key which requires a login, and reads out terminal IDs of candidates of a destination terminal 10 which can communicate with the request source terminal 10. Moreover, the terminal extraction unit 54 searches the destination list management table (see FIG. 10) with the terminal ID of the request source terminal 10 as a search key which requires a login, and searches for terminal IDs of other request source terminals, that are registered candidates of a destination terminal 10 which includes the above request source terminal 10.

The terminal status acquisition unit 55 searches the terminal management table (see FIG. 9), with the terminal ID of the candidate of the destination terminal 10 as a search key extracted by the above terminal extraction unit 54, and reads out operating status for each of the terminal IDs extracted by the terminal extraction unit 54. Accordingly, the terminal status acquisition unit 55 can acquire the operating status of the candidates of the destination terminal 10, which are allowed to communicate with the request source terminal 10, which has required the login. Moreover, the terminal status acquisition unit 55, with the terminal ID as a search key extracted by the terminal extraction unit 54, searches the terminal management table (see FIG. 9), and also acquires the operational status of the request source terminal 10, which has required the login.

The session management unit 57 manages the generated session ID, terminal ID of the request source terminal 10 and terminal ID of the destination terminal 10, by associating them with each other, and stores them in the session management DB 5005 of the storage unit 5000 (the session management table in FIG. 11). Furthermore, the session management unit 57 manages the relay apparatus ID of the relay apparatus 30 by storing them in the session management table (see FIG. 11).

The quality determination unit 58 determines image quality of image data to be relayed by the relay apparatus 30, by searching the quality management table (see FIG. 12) with the above delay time as a search key, and extracts image quality corresponding to the image data. The storage/readout process unit 59 is executed by the HDD 205, shown in FIG. 3, and performs a process of storing various data into the storage unit 5000 and a process of reading out various data stored in the storage unit 5000. The delay time management unit 60 searches the terminal management table (see FIG. 9) with the IP address of the above destination terminal 10, and extracts a corresponding terminal ID. The delay time management unit 60 manages the delay time by storing the delay time indicated by the above delay information into a field of delay time in the record, including the terminal ID, extracted as above, in the session management table (see FIG. 11).

<Functional Configuration of an External Input Device>

FIG. 16 illustrates an example of a functional block diagram of the external input device. The external input device 40, as shown in FIG. 13, includes a transmission/reception unit 41, a connection detection unit 42, an installation determination unit 43a, a program acquisition unit 43b, a display data acquisition unit 451, a display data transmission unit 452, an operation input reception unit 46, a display control unit 47, a mount unit 48, and a storage/readout process unit 49. Each of the above units is a function or a means realized by one of the components, shown in FIG. 3, operating according to an instruction from the CPU 201 following the program stored in the ROM 202. Moreover, the display data acquisition unit 451 and the display data transmission unit 452 are realized by downloading a program for the external input device 1451 stored in the storage unit 1000 of the transmission terminal 10 (see FIG. 4), and by installing the program. Furthermore, the external input device 40 includes a storage unit 4000 configured by the ROM 202, the RAM 203 or the HDD 205, shown in FIG. 3. Moreover, on the external input device 40, an OS (operating system), such as “Windows” (registered trademark), “Mac (registered trademark) OS”, “Mac (registered trademark) OS X Lion”, “Mac (registered trademark) OS X”, “OS X”, or the like, though not especially shown. Accordingly, the external input device is equipped with a function of executing a program when it is connected to the other apparatus.

<Each Functional Element of an External Input Device>

Next, each functional element of the external input device 40 will be explained in detail. The transmission/reception unit 41 (see FIG. 13) is realized by the network I/F 209, shown in FIG. 3, and sends/receives various data (information) to/from the transmission terminal 10. The connection detection unit 42 detects that sending/receiving various data to/from the transmission terminal 10 becomes possible by the external device I/F 215, shown in FIG. 3.

The installation determination unit 43a, when the connection detection unit 42 detects that sending/receiving data between the external input device and the transmission terminal 10 becomes possible, determines whether the program for the external input device 1451 is installed in the external input device 40 or not. The program acquisition unit 43b, when the installation determination unit 43a determines that the program for the external input device 1451 is not installed in the external input device 40, acquires the program for the external input device 1451 from the storage unit 1000 of the transmission terminal 10 (see FIG. 4).

The operation input reception unit 46 receives information input by a user's operation. The display control unit 47 displays an image read out by the storage/readout process unit 49, which will be described later, on the display unit 216. The mount unit 48 mounts the storage unit 1000 of the transmission terminal 10. According to the above processes, the external input device 40 can install the program for the external input device 1451.

The display data acquisition unit 451 acquires display data representing the image displayed on the display unit 216 of the external input device 40. The display data transmission unit 452 transmits the display data acquired by the display data acquisition unit 451 to the transmission terminal 10.

The storage/readout process unit 49 is executed by the HDD 205, shown in FIG. 3, and performs a process of storing various data into the storage unit 4000 and a process of reading out the various data stored in the storage unit 4000.

<<Process and Operation in Present Embodiment>>

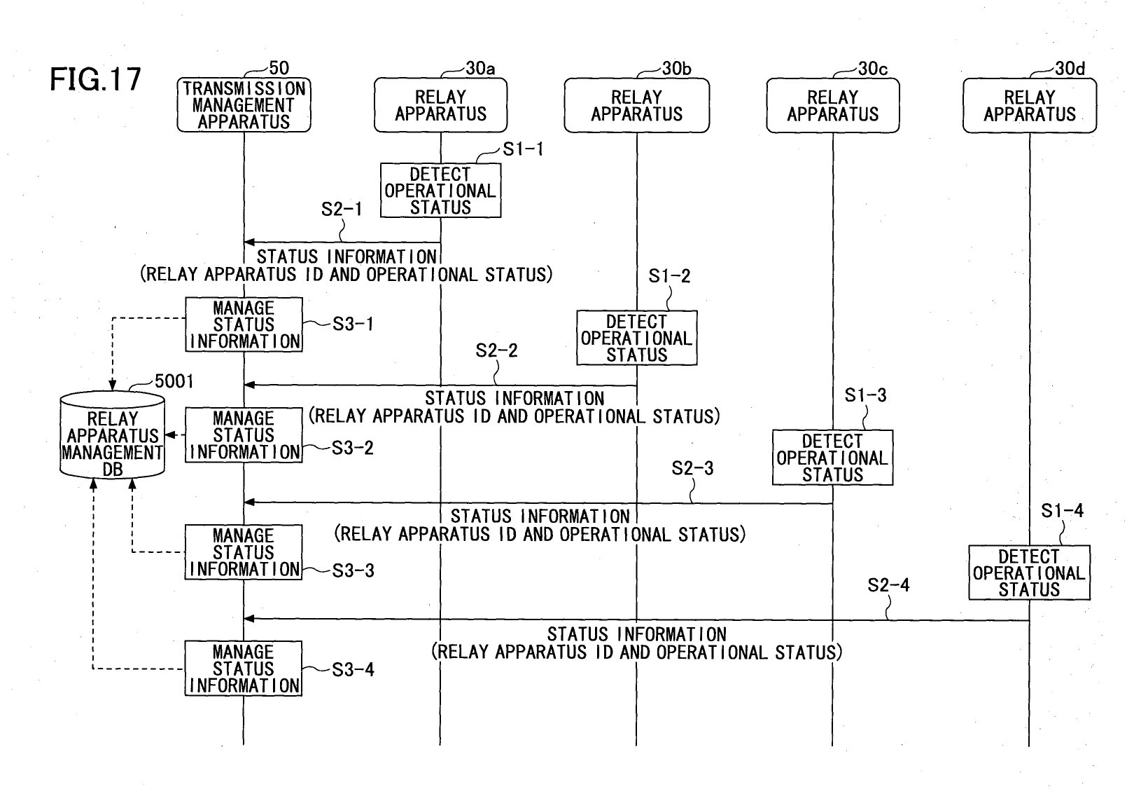

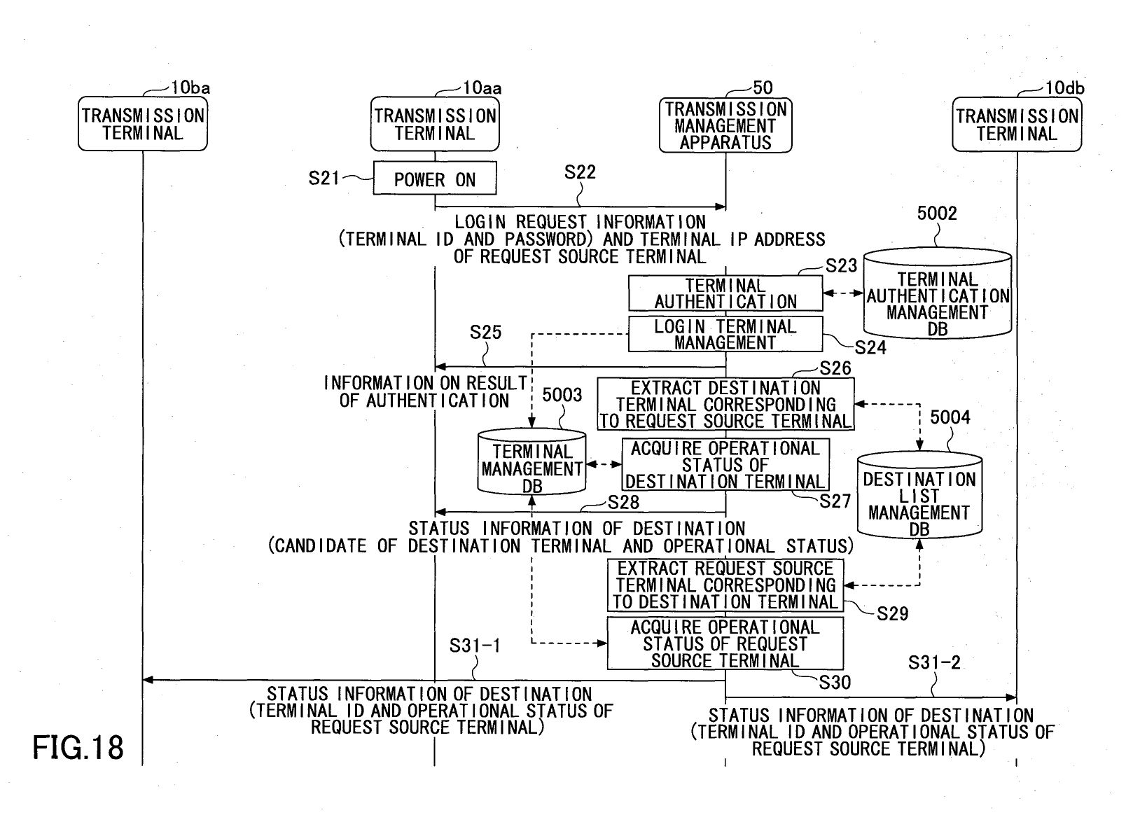

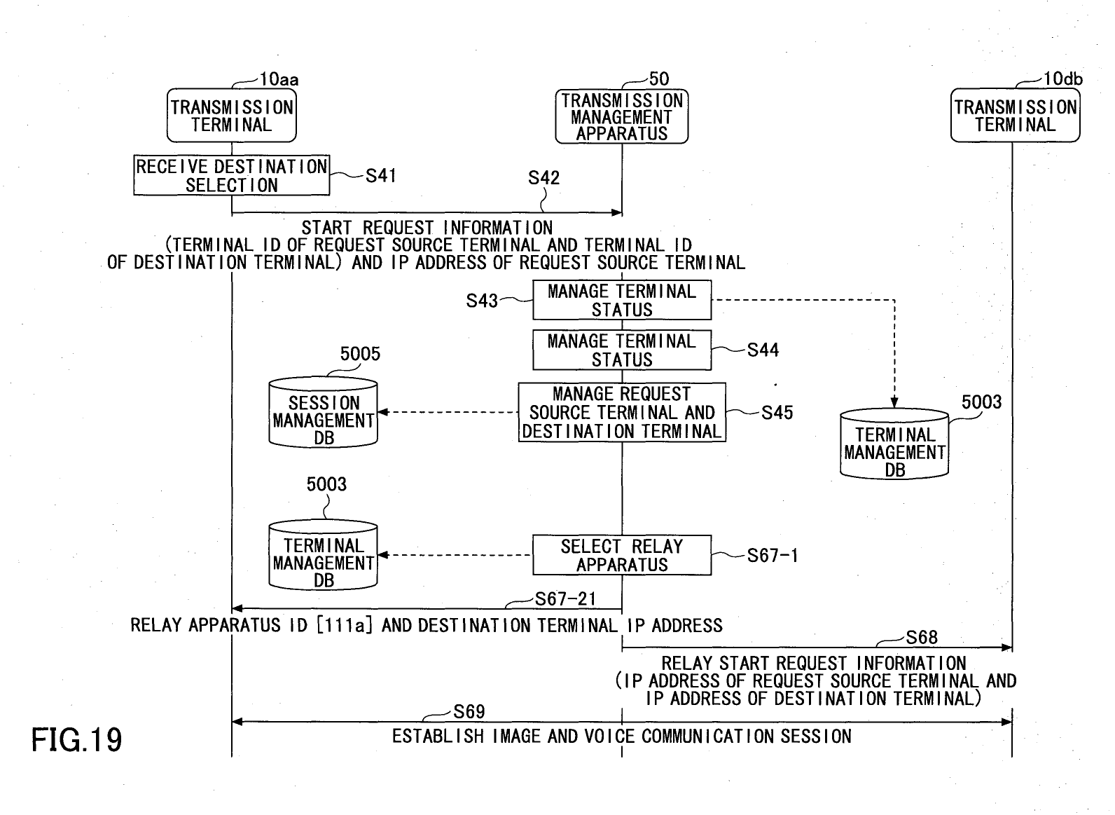

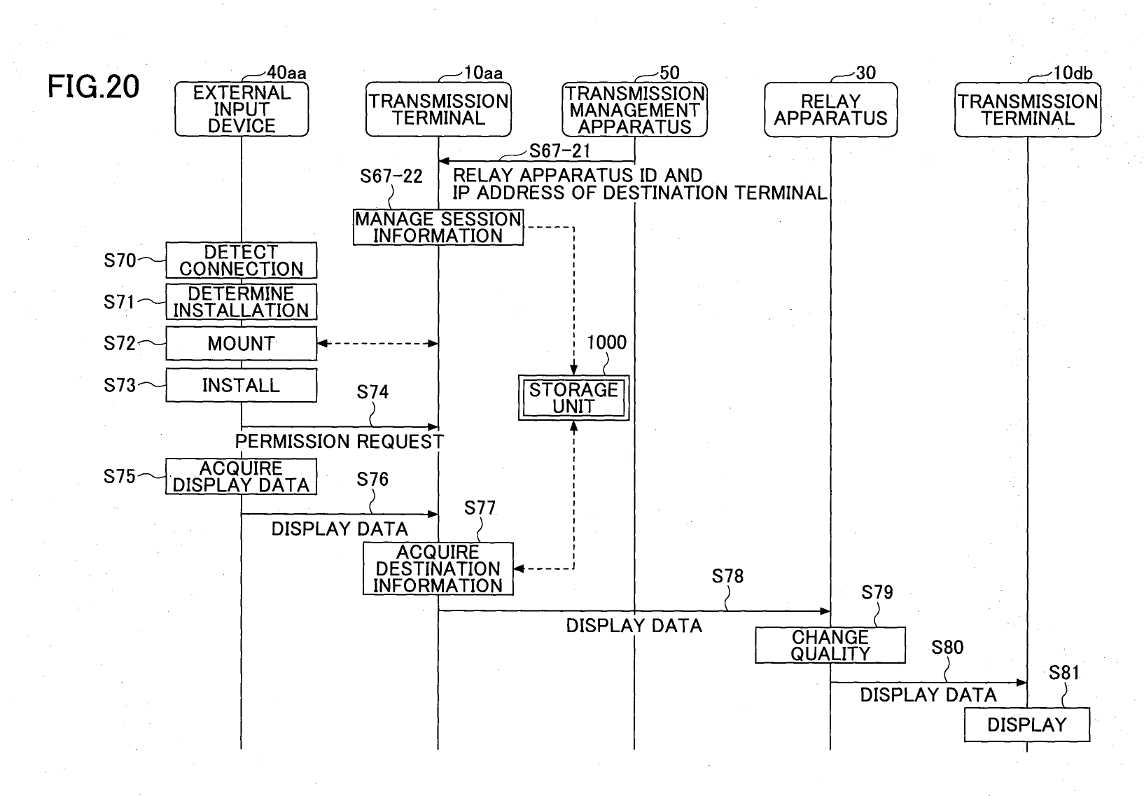

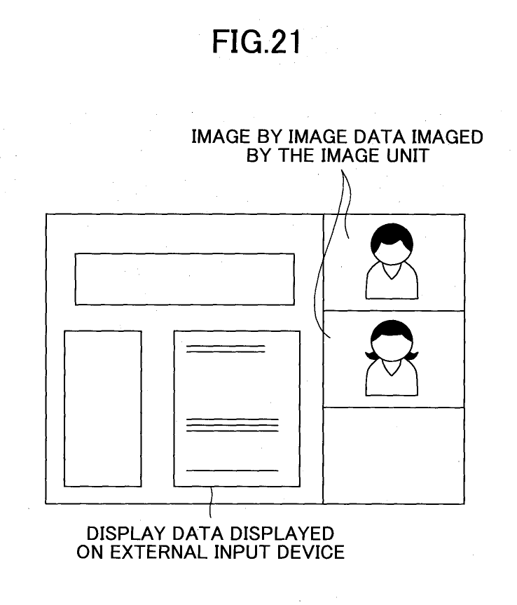

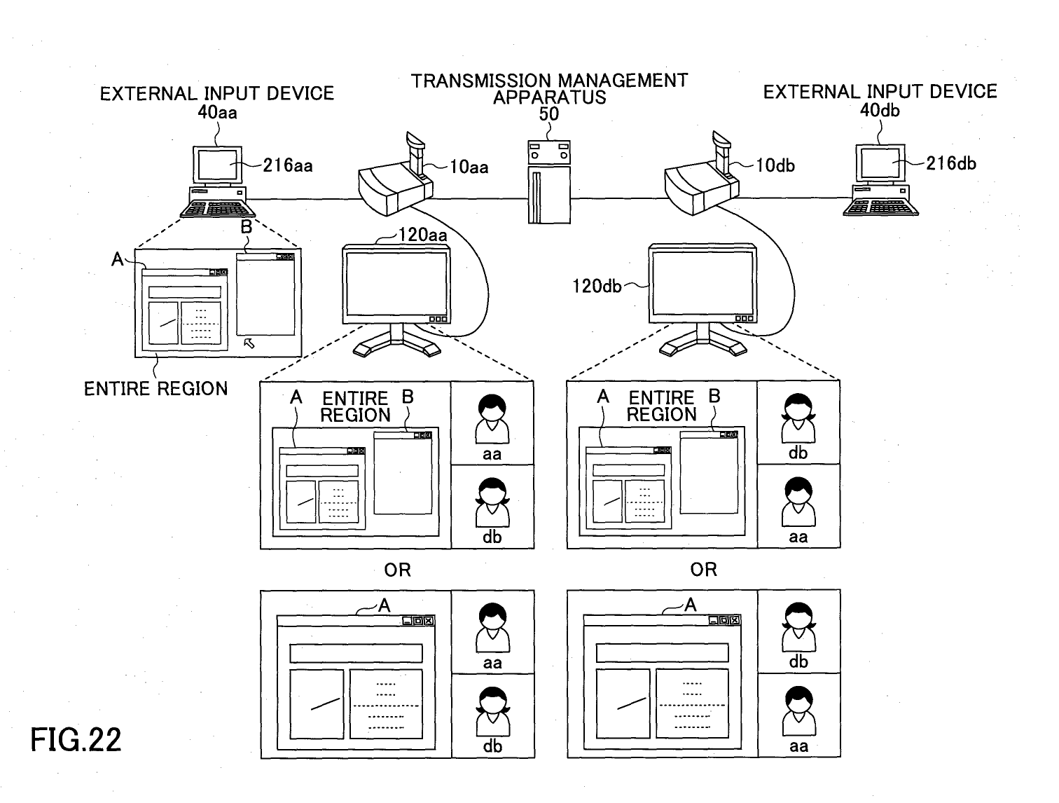

Next, each process performed in the transmission system 1 according to the present embodiment will be explained with reference to FIGS. 17 to 22. FIG. 17 is a sequence diagram illustrating an example of the process of managing the status information, sent from the relay apparatus 30 to the transmission management apparatus 50, which indicates the operational status of the relay apparatus 30. FIG. 18 is a sequence diagram illustrating an example of the process in the preliminary stage for starting the communication between the transmission terminals 10. FIG. 19 is a sequence diagram illustrating an example of the process of establishing a session by the transmission terminal 10. FIG. 20 is a sequence diagram illustrating an example of the process of displaying the display data, displayed on the external input device, on the transmission terminal 10 of the other party in the conference. FIG. 21 is a diagram illustrating an example of display data displayed on the display unit 120. FIG. 22 is an explanatory diagram illustrating an example of screens displayed on the display units 216aa and 216db of the external input device 40aa and 40db, and on the display units 120aa and 120db of the transmission terminals 10aa and 10db in the transmission system 1.

With reference to FIG. 17, the process of managing the status information indicating the operational status of the relay apparatus 30, transmitted from the relay apparatus 30 to the transmission management apparatus 50, will be described. In each of the relay apparatuses 30 (30a to 30d), the status detection unit 32 (see FIG. 4) periodically detects the operational status of the relay apparatus 30, to which the status detection unit 32 belongs (step S1-1 to S1-4). The transmission/reception unit 31 of each of the relay apparatuses 30 periodically transmits the status information to the transmission management apparatus 50 via the communication network 2, so that the transmission management apparatus 50 manages in real time the operational status of the relay apparatuses (step S2-1 to S2-4). The status information includes the relay apparatus ID of the relay apparatus 30 and the operational status detected by the status detection unit 32 of the relay apparatus 30 corresponding to the relay apparatus ID. In the present embodiment, the relay apparatuses 30a, 30b and 30d normal operational states indicate “online”, whereas the operational state of the relay apparatus 30c indicates “offline”, where the relay apparatus 30c operates but has a problem in the program for executing the relaying operation of the relay apparatus 30c.

Next, in the transmission management apparatus 50, the transmission/reception unit 51 receives the status information transmitted from each of the relay apparatuses 30a to 30d, and manages the status information by storing the status information for each of the relay apparatus IDs in the relay apparatus management DB 5001 in the storage unit 5000 (the relay apparatus management table in FIG. 7) via the storage/readout process unit 59 (step S3-1 to S3-4). Accordingly, for the operational statuses of the relay apparatuses 30, as shown in the relay apparatus management table (see FIG. 7), the statuses “online” or “offline”, are stored and managed for the respective relay apparatus IDs. Moreover, the reception time when the transmission management apparatus 50 receives the status information is also stored and managed for each relay apparatus ID. In the case that status information is not sent from the relay apparatus 30, in the relay apparatus management table, shown in FIG. 7, a field of the operational status and a field of the reception time in each record will be blank, or indicate the operational status and the reception time of the status information, received previously.

Next, with reference to FIG. 18, the processes in the preliminary stage before starting the communication between the transmission terminal 10aa and the transmission terminal 10db will be described in the following. At first, when the user turns on the power switch 109, shown in FIG. 2, the operation input reception unit 12, shown in FIG. 4, receives the user's operation, and the power is turned ON (step S21). Next, the login request unit 13, when receiving the operation for turning on the power, automatically sends login request information, indicating a login required, to the transmission management apparatus 50 from the transmission/reception unit 11 via the communication network 2 (step S22). The login request information includes the terminal ID for identifying the transmission terminal 10aa as the request source terminal and the password. The terminal ID and the password have been read out from the storage unit 1000 via the storage/readout process unit 19 and have been transmitted to the transmission/reception unit 11. Moreover, when the login request information is sent from the transmission terminal 10aa to the transmission management apparatus 50, the transmission management apparatus 50 on the reception side can recognize the IP address of the transmission terminal 10aa on the transmission side.

Next, the terminal authentication unit 52 of the transmission management apparatus 50 (see FIG. 4) searches the terminal authentication management DB 5002 in the storage unit 5000 (the terminal authentication management table in FIG. 8) with the terminal ID and the password as a search key included in the login request information received via the transmission/reception unit 51, and performs terminal authentication by determining whether the same terminal ID and the password are managed in the terminal authentication management DB 5002 (step S23). When the terminal authentication unit 52 determines that the login request information is from the transmission terminal 10, which has authorization for use, since the terminal authentication unit 52 manages the same terminal ID and the same password, the status management unit 53 stores in the terminal management DB 5003 (the terminal management table in FIG. 9) the terminal ID, an operational status, a reception time when the login request information is received, and the IP address of the transmission terminal 10aa, which are associated with each other (Step S24). Accordingly, the terminal management table (see FIG. 9), stores the operational status “online”, the reception time “2009.11.10.13:40”, and the IP address of the transmission terminal 10aa “1.2.1.3”, associated with the terminal ID “01aa”.

Next, the transmission/reception unit 51 of the transmission management apparatus 50 sends authentication result information, indicating a result of the authentication obtained by the terminal authentication unit 52, via the communication network 2, to the request source terminal 10aa, which has required the login (step S25). Further, a process when the terminal authentication unit 52 determines the transmission terminal has authorization for use will be explained as follows in the present embodiment.

The terminal extraction unit 54 of the transmission management apparatus 50 searches the destination list management table (see FIG. 10) with the terminal ID “01aa” of the request source terminal 10aa, which has required the login, as a search key, and extracts the terminal ID of a candidate of a destination terminal 10, which can communicate with the request source terminal 10aa, by reading out from the destination list management table (step S26). In the present embodiment, the terminal ID “01ab”, “01ba” and “01db” of the destination terminals 10ab, 10ba and 10db corresponding to the terminal ID “01aa” of the request source terminal 10aa, are extracted.

Next, the terminal status acquisition unit 55 searches the terminal management table (see FIG. 9) with the terminal IDs of the candidates of the destination terminal 10 as a search key extracted by the terminal extraction unit 54 (“01ab”, “01ba”, “01db”), and acquires, by reading out an operational status (“offline”, “online”, “online”) for each terminal ID, extracted by the terminal extraction unit 54, the operational status of each of the destination terminals 10ab, 10ba or 10db (step S27).

Next, the transmission/reception unit 51 sends destination status information including the terminal IDs used as the search key at step S27 (“01ab”, “01ba” and “01db”) and the operational statuses (“offline”, “online” and “online”) of the transmission terminals (10ab, 10ba, and 10db) corresponding to the terminal IDs, to the request source terminal 10aa via the communication network 2 (step S28). Accordingly, the request source terminal 10aa can recognize the operational status (“offline”, “online”, and “online”) at present of each of terminals (10ab, 10ba and 10db) as the candidates of the destination terminal 10, which can communicate with the request source terminal 10aa.

Furthermore, the terminal extraction unit 54 of the transmission management apparatus 50 searches the destination list management table (see FIG. 10) with reference to the terminal ID “01aa” of the request source terminal 10aa, which has required the login, as a search key, and extracts terminal IDs of other request source terminals 10, which are registered as candidates of a destination terminal 10 which includes the above request source terminal 10aa with the terminal ID “01aa” (step S29). In the destination list management table, shown in FIG. 10, the terminal IDs of the other request source terminals 10 extracted as above, are “01ab”, “01ba” and “01db”.

Next, the terminal status acquisition unit 56 of the transmission management apparatus 50, searches the terminal management table (see FIG. 9) with the terminal ID “01aa” of the request source terminal 10aa, which required the login, as a search key, and acquires the operational status of the request source terminal 10aa (step S30).

Next, the transmission/reception unit 51 sends, to the transmission terminals (10ba and 10db) with the operational status of “online”, in the terminal management table (see FIG. 9), out of the transmission terminals (10ab, 10ba and 10db) corresponding to the terminal IDs (“01ab”, “01ba” and “01db”), extracted at step S29, destination status information including the terminal ID “01aa” of the request source terminal 10aa acquired at step S30 and the operational status of “online” (steps S31-1 and S31-2). When the transmission/reception unit 51 sends the destination status information to the transmission terminals 10ba and 10db, based on the terminal IDs (“01ba” and “01db”), the transmission/reception unit 51 refers to the IP addresses of the transmission terminals managed in the terminal management table (see FIG. 9). Accordingly, the transmission/reception unit 51 can transfer, to each of the other destination terminals 10ba and 10db, which can communicate with the request source terminal 10aa having required the login, as a destination, the terminal ID “01aa” of the request source terminal 10aa, which required the login, and the operational status of “online”. On the other hand, in the other terminals 10, when the user turns on the power switch 109, as shown in FIG. 2 (step S21, as above), the operation input reception unit 12 (see FIG. 4) receives the operation for the power to be ON. Since the same processes as in steps S22 to S31-1 and S31-2 are performed, an explanation is omitted.

Next, with reference to FIG. 19, the process of establishing the session by the transmission terminal will be explained in the following. In the present embodiment, the request source terminal 10aa can communicate with at least one of the transmission terminals 10ba and 10db with the operational status of “online”, out of the transmission terminals 10 as the candidates of the destination terminal, according to the destination status information received at step S28 as above. Accordingly, in the following description, processes in the case where a user of the request source terminal 10aa selects to start communicating with the destination terminal 10db will be explained.

At first, the user selects the transmission terminal 10db by depressing the operation button 108 (see FIG. 2) to select the transmission terminal 10db, then the operation input reception unit 12 (see FIG. 4) receives the selection to assign the transmission terminal 10db to the destination (step S41). Next, the transmission/reception unit 11 of the transmission terminal 10aa sends start request information, including the terminal ID “01aa” of the request source terminal 10aa and the terminal ID “01db” the destination terminal 10db, and indicates that starting the communication is required, to the transmission management apparatus 50 (step S42). According to the above processes, the transmission/reception unit 51 of the transmission management apparatus 50 receives the start request information and can recognize the IP address “1.2.1.3” of the request source terminal 10aa as the transmission source. The status management unit 53, based on the terminal ID “01aa” of the request source terminal 10aa and the terminal ID “01db” of the destination terminal 10db, included in the start request information, in the terminal management table (see FIG. 9) of the terminal management DB 5003, changes both of the fields of the operational status in the records, each including the terminal ID “01aa” or the terminal ID “01db”, to “busy” (step S43). In this stage, although both the request source terminal 10aa and the destination terminal 10db have not yet started communicating with each other, both transmission terminals 10 have transitioned to a busy state. When an other terminal tries to communicate with the request source terminal 10aa or the destination terminal 10db, a sound or a display indicating a busy state is output.

The transmission management apparatus 50 generates a session ID for selection used for executing the session for selecting the relay apparatus 30 (step S44). The session management unit 57 stores the session ID for selection “set”, generated at step S44, the terminal ID “01aa” of the request source terminal 10aa, and the terminal ID “01db” of the destination terminal 10db, which are associated with each other, into the session management table (see FIG. 11) of the storage unit 5000, and manages them (step S45).

After that, the transmission management apparatus 50 refines the selection for the relay apparatus 30, which relays communication between the request source terminal 10aa and the destination terminal 10db, based on the relay apparatus management DB 5001 and the terminal management DB 5003. However, further explanation in detail will be omitted.

Next, the session management unit 57 of the transmission management apparatus 50, in the session management table (see FIG. 11) of the session management DB 5005, stores the relay apparatus ID “111a” of the relay apparatus 30a, selected above as the final one, in the field of the relay apparatus ID in the record including the session ID for selection “se1”, and manages it (step S67-1). The transmission/reception unit 51 sends the relay apparatus ID “111a” and the IP address (“1.3.2.4”) of the destination terminal 10db to the request source terminal 10aa (step S67-21). The transmission/reception unit 51 of the transmission management apparatus 50 sends the relay start request information, indicating that commencement of relaying is required, to the relay apparatus 30a via the communication network 2 (step S68). The relay start request information includes the IP addresses of the request source terminal 10aa and the destination terminal 10db, which are relayed as “1.2.1.3” and “1.3.2.4”. According to the above processes, the relay apparatus 30 establishes a session to send/receive three kinds of image data of the low image quality, intermediate image quality and a high image quality, and data between the transmission terminals 10aa and 10db (step S69). Accordingly, each of the transmission terminals 10aa and 10db can start a video conference. The number of kinds of image quality is not limited to three as in the present embodiment. The number of the kinds of image quality may be greater than three or may be less than three.

Each transmission terminal 10 according to the present embodiment sends/receives image data by using a standard for video encoding, such as H.264 (H.264/AVC, MPEG-4 part 10, MPEG4 AVC), H.264/SVC, which is the extended standard thereof, or MPEG-2.

Next, with reference to FIG. 20, the process of sending display data representing an image, displayed on the display unit 216 of the external input device 40, to the other terminal 10, and displaying the display data on the display unit 120 of the other terminal 10, after the relay apparatus is determined, will be explained as follows. In the present embodiment, the process in the case where information displayed on the external input device 40aa connected to the transmission terminal 10aa is displayed on the transmission terminal 10db, which is the destination terminal, will be explained as an example.

When the relay apparatus 30 is determined as above, the transmission/reception unit 11 of the transmission terminal 10aa receives the relay apparatus IP “111a” and the IP address “1.3.2.4” of the destination terminal 10db, which the transmission management apparatus 50 sends at step S67-21. The storage/readout process unit 19 stores the received relay apparatus ID “111a” and the IP address “1.3.2.4” into the storage unit 1000 (step S67-22).

Moreover, when the external input device 40aa is connected to the transmission terminal 10aa, the connection detection unit 42 (see FIG. 13) of the external input device 40aa detects the connection (step S70). At the time of starting up the external input device 40aa, the display control unit 47 displays a screen including at least the whole region. When the connection detection unit 42 detects the connection of the external input device 40aa to the transmission terminal 10aa, the installation determination unit 43a determines whether the external input device 40aa is equipped with the display data acquisition unit 451 and the display data transmission unit 452 (step S71). Specifically, the installation determination unit 43a determines whether the program for the external input device 1451 is installed in the external input device 40aa. If each of the programs for the external input device 1451 is installed, the installation determination unit 43a determines that the external input device 40aa is equipped with the functional element corresponding to the program.

On the other hand, when the installation determination unit 43a determines that the external input device is not equipped with any of the display data acquisition unit 451 or the display data transmission unit 452, the mount unit 48 mounts the storage unit 1000 of the transmission terminal 10aa (step S72). Next, the program acquisition unit 43b acquires the program for the external input device 1451 stored in the storage unit 1000 of the transmission terminal 10, and installs the acquired program in the external input device 40aa (step S73). According to the above process, the external input device 40aa is equipped with the display data acquisition unit 451 and the display data transmission unit 452. Meanwhile, the program for external input device 1451 may be installed in the external input device 40aa in advance.

After the process at step S73, the transmission/reception unit 41 sends information requiring a permission to transmit the display data to the transmission terminal 10aa (step S74). When the transmission/reception unit 41 receives information indicating the permission in response to the requirement from the transmission terminal 10aa, the display data acquisition unit 451 acquires display data representing the image displayed on the display unit 216 (step S75).

The resolution of the display data may be changed in this stage. When the resolution of the display unit 216 is different from the resolution of the display unit 120, the display data can be displayed appropriately.

When the external information transmission/reception unit 18 of the transmission terminal 10aa, as the transmission source, receives the display data from the external input device 40aa, the storage/readout process unit 19 reads out the relay apparatus ID “111a” and the IP address “1.3.2.4” of the transmission terminal 10db, as the destination, stored in the storage unit 1000 (step S77).

The transmission/reception unit 11 sends, to the relay apparatus 30 specified by the relay apparatus ID “111a” read out at step S74, the display data, the resolution of which is converted, and the IP address “1.3.2.4” of the transmission terminal, as the destination (step S78).

When the relay apparatus 30 receives the display data transmitted from the transmission terminal 10aa at step S78, the relay apparatus 30 changes the image quality of the display data based on the IP address “1.3.2.4” of the transmission terminal 10db, as the destination (step S79), and sends the display data to the transmission terminal 10db (step S80).

When the transmission/reception unit 11 of the transmission terminal 10db receives the display data sent from the relay apparatus 30, the image display control unit 14b displays an image represented by the received display data on the display unit 120 (step S81). FIG. 21 is a diagram illustrating an example of a display screen displayed on the display unit. In the left-hand area of the screen, the display data displayed on the external input device 40aa are displayed. In the upper right area of the screen, image data imaged by the image unit 14a of the transmission terminal 10aa and sent from the transmission/reception unit 11 are displayed. Moreover, in the lower right area of the screen, image data imaged by the image unit 14a of the transmission terminal 10db are displayed.

FIG. 22 is an explanatory diagram illustrating an example of screens displayed on the display units of the external input devices 40aa and 40db, and the display units 120aa and 120db connected to the transmission terminals 10aa and 10db respectively, in the whole configuration of the transmission system 1. On the display unit of the external input device 40aa, a screen, which the user shares with the transmission terminal 10db, is displayed. The screens displayed on the external input devices 40aa and 40db are denoted as “desktop screens”. In one region of the whole of the desktop screen (in the following, denoted “whole region”) plural regions can be displayed (no region may be displayed). In FIG. 22, as an example, region “A” and region “B” are displayed in the whole region of the screen of the external input device 40aa.

According to the process illustrated in FIG. 20, the transmission terminal 10aa displays image data and display data on the display unit 120aa, and the transmission terminal 10db displays image data and display data on the display unit 120db. In the following, the screens displayed on the display unit are denoted as “display screens”. In the display screens of the upper row in FIG. 22, the whole region is displayed as the display data, and a user “aa” of the transmission terminal 10aa and a user “db” of the transmission terminal 10db are displayed as the image data. In the display screens of the lower row in FIG. 22, region “A” is displayed as the display data, and the user “aa” of the transmission terminal 10aa and the user “db” of the transmission terminal 10db are displayed as the image data. At each of the display screens, the user can select the whole region, arbitrary region “A” or region “B”, to display on the display screen. Meanwhile, even when the user “aa” changes the display screen, on the display unit 216db of the external input device 40db the whole region and the region which the user “db” displays remain displayed, and are not affected by the operation of the user “aa”.

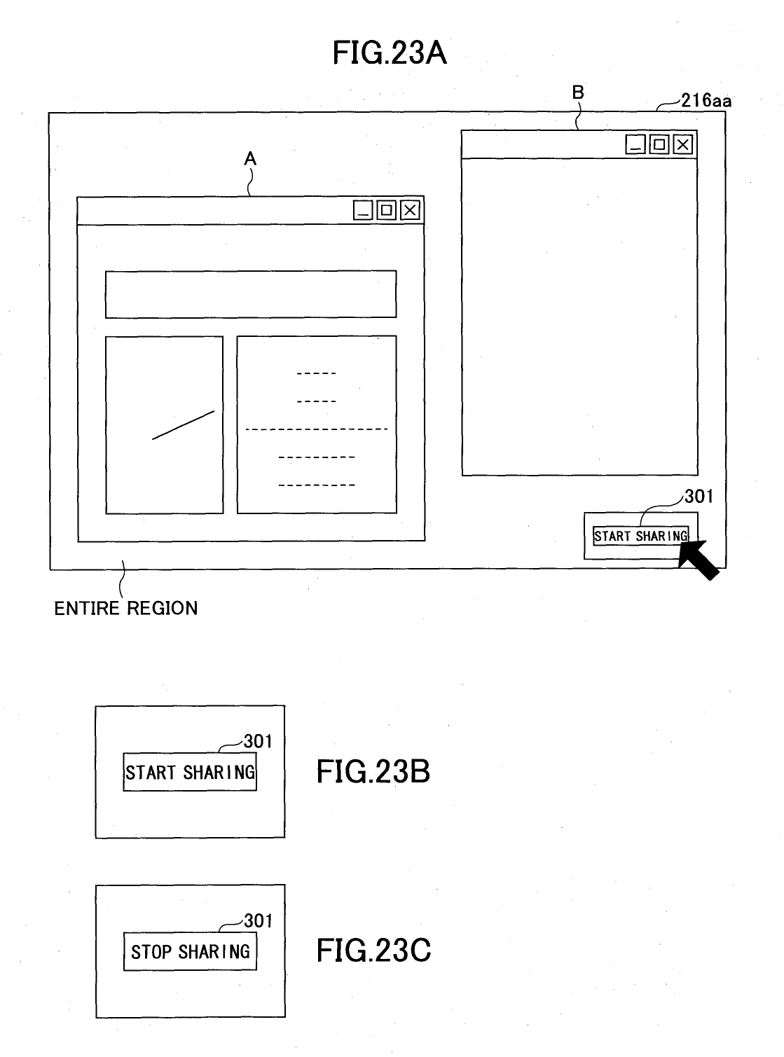

FIG. 23A illustrates an example of a desktop screen displayed on the external input device 40aa. In the external input device 40aa, the program for external input device is installed. For example, on the bottom-right corner of the desktop screen, a shared setting reception button 301 is displayed constantly or according to a user's predetermined operation. The predetermined operation is, for example, clicking or double-clicking an icon image on the screen representing the program for external input device by the pointing device, hovering the mouse over an icon, or the like.

FIGS. 23B and 23C are enlarged views of examples of the shared setting reception button 301 according to the present Example. In FIG. 23B, a character string “start sharing” is displayed on the shared setting reception button 301. In FIG. 23C, a character string “stop sharing” is displayed on the shared setting reception button 301. When the user clicks the shared setting button 301 in FIG. 23B by the pointing device, sharing the display data displayed on the display unit 216aa of the external input device 40aa starts. Moreover, during the display data displayed on the display unit 216aa of the external input device 40aa are shared, the image of the shared setting reception button 301 in FIG. 23C is displayed. When the user clicks the shared setting button 301 in FIG. 23C by the pointing device, sharing of the display data displayed on the display unit 216aa of the external input device 40aa with the transmission terminal 10db stops, i.e. the display data ceases to be sent to the transmission terminal 10aa.

The operation input reception unit 46, as shown in FIG. 13, receives the user's operation for the shared setting reception button 301. The display data acquisition unit 451, when the user clicks the shared setting reception button 301, on which the character string “start sharing” is displayed, acquires a region selected by the user as the display data.

In the transmission system 1 according to the present embodiment, the display data of the whole region or a specific region displayed on the external input device 40 at the time when the shared setting reception button 301 with “start sharing” is finally clicked is shared. Accordingly, in the case where the user “db” clicks the shared setting reception button 301 on which the character string “start sharing”, in FIG. 23B, is displayed, sharing of the display data on the display unit 216aa stops automatically, without clicking the shared setting reception button 301 with “stop sharing” by the user “aa”, shown in FIG. 23C.

[Example of Screen Displayed by Terminal]

A layout of the screen which the transmission terminal 10 displays on the display unit 120 can be changed. For example, the layout (screen layout) changes according to the following mode (an example of a display mode recited in claims) for example.

A multi-view mode, which displays an image of the other party in the conference mainly, and small images of the rest of the locations including the self-location on the right part, the left part and the lower part of the screen;

A PandP mode, in which participating locations including the self-location are arranged with the same size; and

A full screen mode.

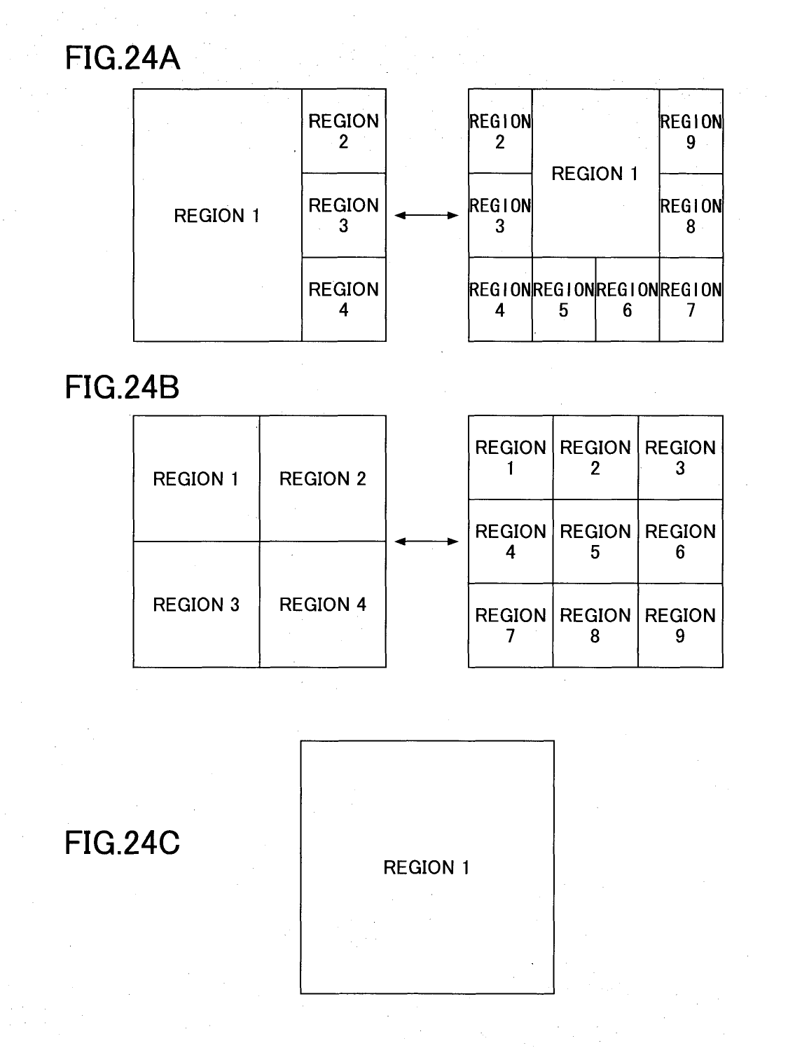

FIGS. 24A to 24C are examples of the respective layouts of the display screen. FIG. 24A illustrates the layout of the multi-view mode. FIG. 24B illustrates the layout of the PandP mode. FIG. 24C illustrates the layout of the full screen mode. A user can select a layout of the display screen.

An upper limit of a number of the transmission terminals which can participate in one conference is limited by a band frequency of a network, a specification of the transmission management apparatus 50, a specification of the relay apparatus or the like. Moreover, a number of regions which can be displayed on each of the transmission terminal at a time is also limited according to a specification of the transmission terminal. However, practically, sufficiently large numbers for the upper limit and for the number of regions are ensured. When the upper limit is different from the number of regions, i.e. the upper limit is larger than the number of regions, the transmission terminal (location) 10, image data or display data of which are displayed in the region, is determined as follows.

Moreover, there are plural transmission terminals on the other side in the conference which participate in the conference, the display image determination unit determines a transmission terminal, image data or display data of which are displayed in each region.

In the case of the multi-view mode, the display image determination unit 17 determines, for example, that image data or display data of the transmission terminal, a volume of sound data of which is the maximum, are displayed in region 1. Accordingly, image data or display data of the transmission terminal used by the user who is speaking can be displayed with a large size.

The display image determination unit 17 allocates the rest of regions having an equal size (regions 2 to 4, or regions 2 to 9) to the respective transmission terminals in order of participating in the conference, for example. Accordingly, the regions are occupied from the upper end, and the user can check each participant easily.

Meanwhile, for image data or display data of the self-location a predetermined region out of regions 2 to 4 or regions 2 to 9 is allocated based on the predetermined rule, for example, the lower right region.

In the case of the PandP mode, the display image determination unit 17 allocates the regions having an equal size, regions 1 to 4 or regions 1 to 9, to the respective transmission terminals in order of participating in the conference, for example. The display image determination unit 17 may determine that image data or display data of the transmission terminal, a volume of sound data of which is the maximum, are displayed in region 1. In this case, although the size is equal, the image data or the display data of the terminal used by the user who is speaking can always be displayed in region 1. To the image data or the display data of the self-location, a predetermined region, for example, the lower right region, is allocated.

In the case of the full screen mode, the display image determination unit 17 determines that image data or display data of the transmission terminal 10, a volume of sound data of which is the maximum, are displayed in region 1.

Meanwhile, in any of the above modes, a correspondence between the region and the location, which was once determined by the display image determination unit 17, is not necessarily fixed. For example, the user can allocate image data or display data transmitted from the arbitrary location to the arbitrary region.

[Generation of Arrangement Information Management Table]

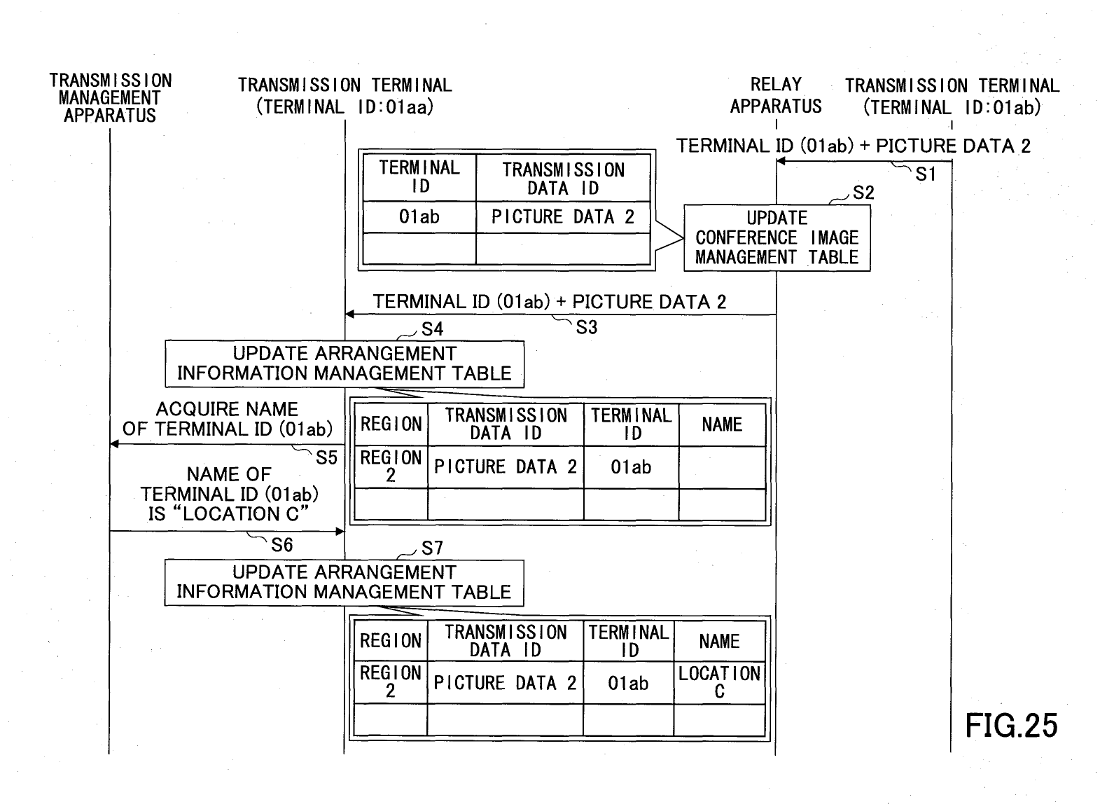

FIG. 25 is an example of a sequence diagram illustrating procedures of generating the arrangement information management table by the arrangement information management table update unit 22. In this example, a session between more than one transmission terminal has already been established. Assume that a terminal ID of the transmission terminal “A” is 01aa and a terminal ID of the transmission terminal “B” is 01ab.

The transmission terminal 01ab sends image data or display data, which is image data 2 in the figure, via the relay apparatus 30 (step S1).

When the relay apparatus 30 receives new image data or display data, the relay apparatus 30 updates the conference image management table (step S2). In the case of receiving the image data, a transmission data ID is added to the image data transmitted from the transmission terminal 01ab. Meanwhile, in the following explanation, either of the image data or the display data are sent to the replay apparatus, but both of the image data and the display data may be sent.

The relay apparatus 30 sends the image data, to which the transmission data IDs, such as the terminal ID and image data 2 are added, to all the transmission terminals 10, with which sessions have been established, including the transmission terminal 01aa (step S3).

The arrangement information management table update unit 22 in the transmission terminal “A” updates the arrangement information management table (step S4). Since the display image determination unit 17 determines to which region image data are allocated, as above, values are registered in “region”, “transmission data ID” and “terminal ID” in the arrangement information management table.

The name acquisition unit 21 requires a name connected to the terminal ID of 01ab from a name management table, a transmission source of which is a transmission terminal having a terminal ID of 01aa, stored in the transmission management apparatus 50 (step S5). The name management table, a transmission source of which is a transmission terminal having a terminal ID of 01aa may be downloaded from the transmission management apparatus 50 at step S5 or at a timing before step S5.

The name acquisition unit 21 acquires a name of, for example, “Location C” from the transmission management apparatus 50 (step S6).

The arrangement information management table update unit 22 updates the arrangement information management table using the name (step S7). That is, “Location C” is registered in “Name” in the arrangement information management table.

By performing the above process for the other terminals with which sessions have been established, regions, to which all the transmission terminals with the established sessions are allocated, the terminal IDs, data type and the name are registered in the arrangement information management table.

Accordingly, in the case where the relay apparatus delivers image data, to which a transmission data ID including image data 2, to transmission terminals after the conference starts, each of the transmission terminals specifies the name according to the transmission data ID (image data 1) and can incorporate the name in the image data 1.

Since the transmission terminal has the arrangement information management table, a delay when the transmission terminal incorporates the name of data in image data or display data can be suppressed compared with the case of inquiring from the transmission management apparatus 50 in each case.

Meanwhile, the transmission terminal 10 may always include the arrangement information management table in advance. However, since the relay apparatus gives the transmission data ID dynamically, the correspondence between the transmission data ID and the terminal ID may be changed. For this reason, as in the present embodiment, the arrangement information management table is preferably generated by the transmission terminal 10 at the time when the conference starts.

Meanwhile, although in the sequence diagram, a procedure of acquiring the name of the self-location is not explicitly shown, the name of the self-location is acquired from the transmission management apparatus 50 at the time of startup of the transmission terminal. Or, for the self-location, a name in the initial setting (for example, “self-location”) is set to the transmission terminal in advance, and the name of self-location may be displayed without acquiring from the transmission management apparatus 50. Or, a name may not be displayed in the region where the image data or the display data of the self-location are displayed.

[Example of Display]

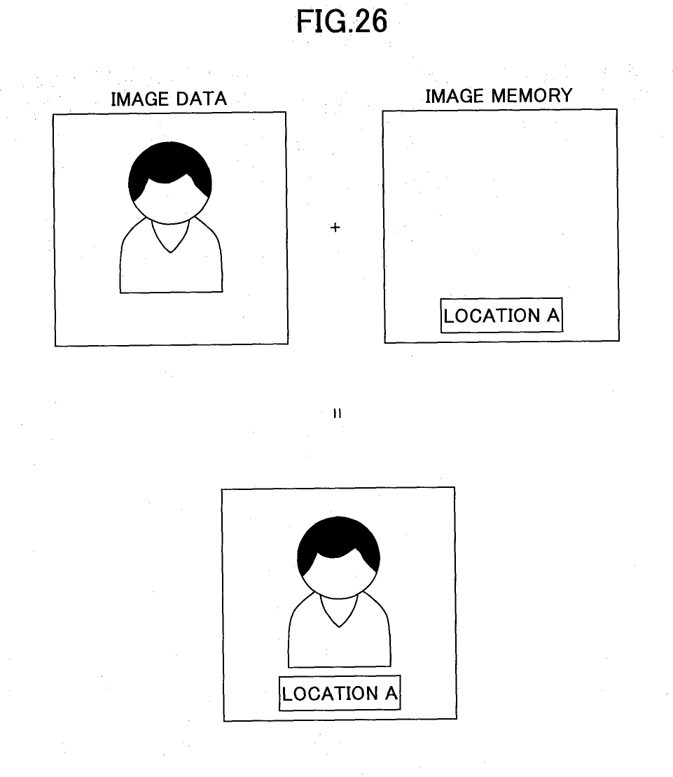

FIG. 26 is an example of diagram for schematically explaining an overlaying of a name. A name overlaying unit 23 incorporates a name in image data or display data which are sent in JPEG, BMP or the like by performing a pixel operation. For example, pixel value data obtained by rendering the name in an image memory having the same size as the image data or the display data are prepared. The name overlaying unit 23 overwrites pixel values corresponding to the name of the image data or the display data with pixel values of the image memory (replaces).

Moreover, the pixel values may be added or subtracted, not overwritten. Furthermore, the name may be made translucent by taking an average of the pixel values corresponding to the name of the image data and the pixel values of the image memory, and the name may be overlaid over the image data.

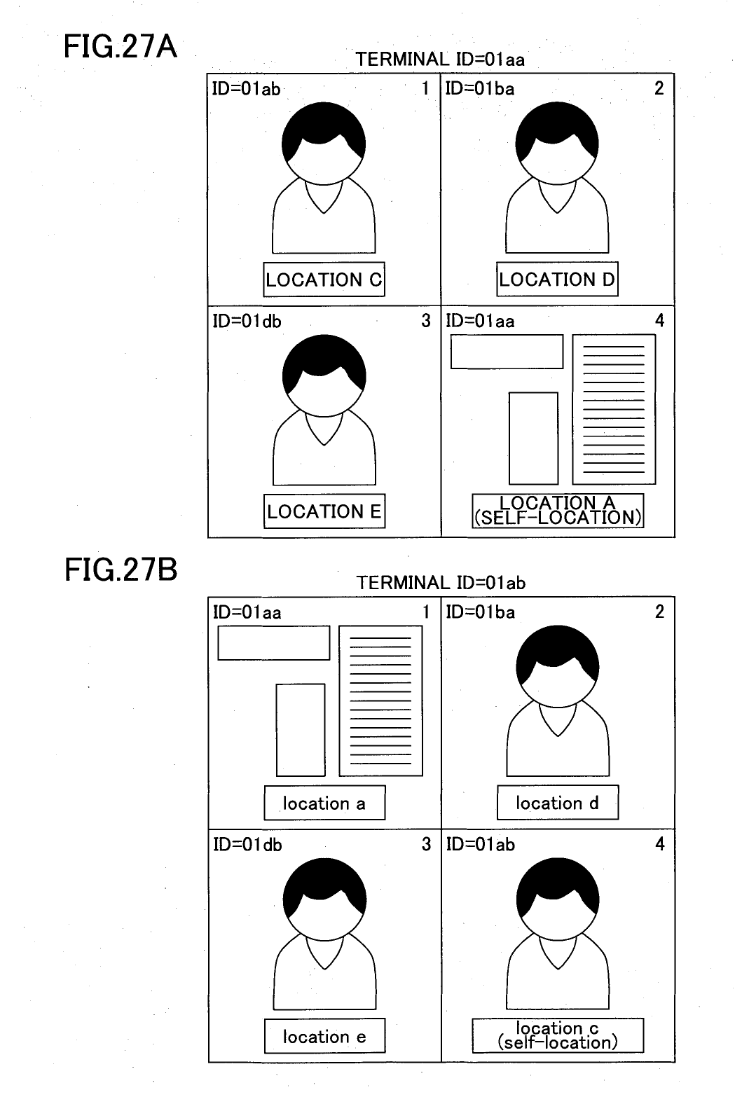

FIGS. 27A and 27B are examples of display screens displayed on the display unit 120 of each of the transmission terminals. FIGS. 27A and 27B are the display screens of the transmission terminals having the terminal IDs of 01aa and 01ab, respectively. Both of the display screens include regions 4 in which the image data or the picture data of the self-location are displayed.

In the conference, the transmission terminals with the terminal IDs of 01aa and 01ab are in discussion, and the other terminals with the terminal IDs of 01ba and 01db can be viewed in common from both of the transmission terminals (01aa and 01ab). On the display screens of both of the transmission terminals (01aa and 01ab), image data or display data of the transmission terminals having the terminals IDs of 01aa, 01ab, 01ba and 01db are displayed. However, on the display unit 120 of the transmission terminal having the terminal ID of 01aa, as shown in FIG. 27A, the names are displayed in upper case characters, whereas on the display unit 120 of the transmission terminal having the terminal ID of 01ab, as shown in FIG. 27B, the names are displayed in lower case characters.

Accordingly, the representation of the name of the transmission terminal 10 can be changed for each user of the transmission terminal. Moreover, the representation of the name of the transmission terminal 10 can be changed arbitrarily by the user and registered in the transmission management apparatus 50.

[Update of Arrangement Information Management Table]

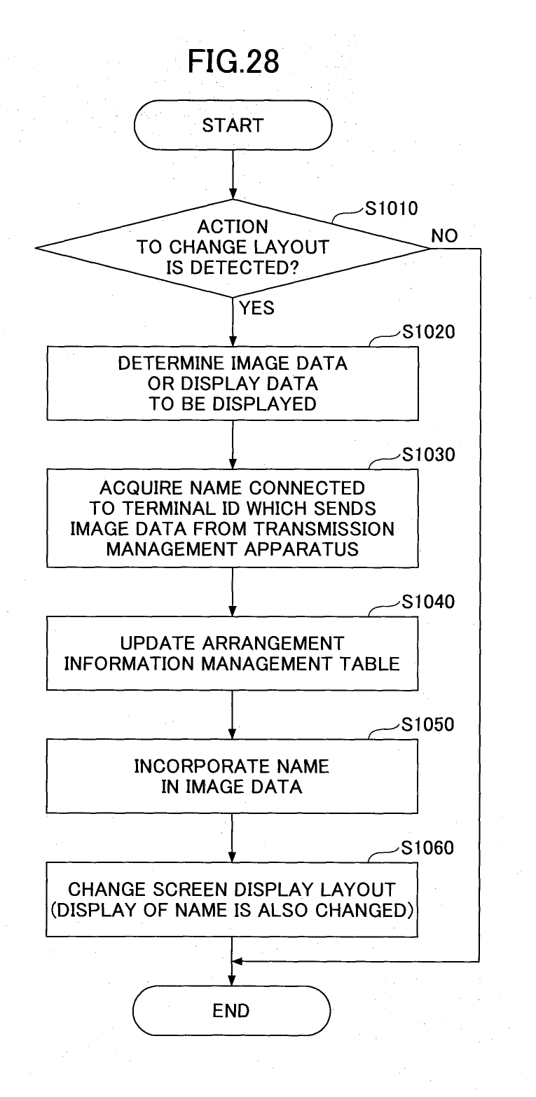

FIG. 28 is an example of a flowchart illustrating a process of updating the name. The transmission terminal 10 associates the name and the region correctly and displays the display screen each time the layout is changed.

The arrangement information management table update unit 22 determines whether an action to change the layout is detected (step S1010). The actions to change the layout include following events:

(a) an operation of changing a mode by a user;

(b) an operation of displaying new display data by the user;

(c) an operation of displaying new image data by the user;

(d) an increase of the locations; and

(e) a decrease of the locations.

The operation (a) is detected by the operation input reception unit 12. The operation for the user's self-location out of the operations (b) and (c) is detected by the external information transmission/reception unit 18. The operation for the other locations out of the operations (b) and (c) is detected by receiving from the relay apparatus a notice that a data type of data sent from a certain transmission terminal has been switched. The event (d) is detected by acquiring a terminal ID of a new location and a transmission data ID. The event (e) may be detected by detecting that a session has ended, or by using a notice from the transmission management apparatus 50.

When the action to change the layout is detected (step S1010: YES), the display image determination unit 17 determines image data or display data to be displayed (step S1020). At first, if the mode is changed, a layout in the mode after the change is specified. While setting the number of regions displayed in the specified layout to the upper limit, image data or display data to be displayed from plural locations are determined. When the number of regions is not limited, all image data or display data may be displayed without determining the image data or the display data to be displayed.

The name acquisition unit 21 acquires a name connected to a terminal ID of the transmission terminal which sends the image data or the display data determined to be displayed in the name management table connected to the terminal ID of the self-location (step S1030). All terminal IDs of transmission terminals with which sessions are established are registered in the arrangement information management table.

The arrangement information management table update unit 22 updates the arrangement information management table (step S1040). That is, regions for the image data or the display data determined to be displayed are determined. The regions determined as above are associated with the transmission data IDs, the terminal IDs and the names, and are registered.

Next, the name overlaying unit 23 incorporates a name in image data or display data for each region (step S1050). That is, based on the transmission data ID sent with the image data or the display data from the relay apparatus, the name is read out from the arrangement information management table, and is incorporated into the image data or the display data.

The image display control unit displays a display screen on the display unit 120 in the layout according to the mode and the number of locations. That is, a position of each of the regions is determined based on the layout, the image data or the display data are reduced, enlarged or the like according to the size of each of the regions, and the image data or the display data in which the name is incorporated are arranged in each of the regions.

In this way, since the arrangement information management table is updated each time the layout is changed, even if the layout is changed during the conference, the correspondence between the region and the name can be maintained correctly.

[Variation]

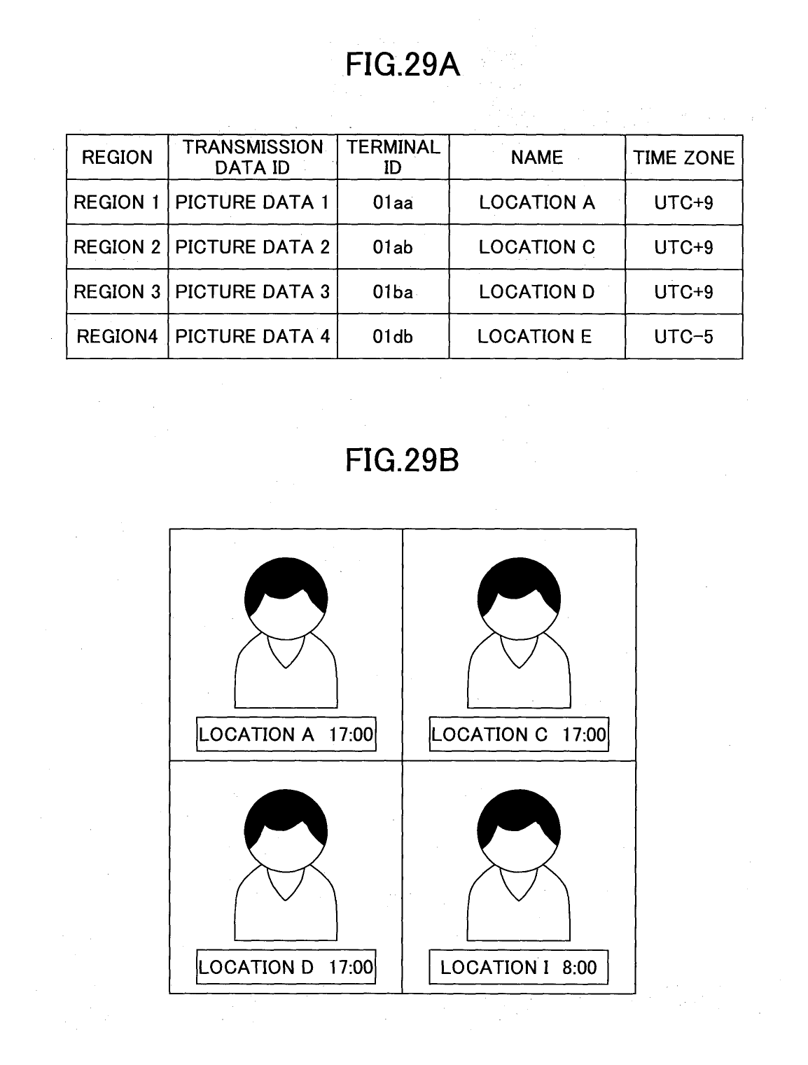

FIG. 29A is a diagram illustrating another example of the arrangement information management table. FIG. 29B is a diagram illustrating another example of the display screen. In the present example, the arrangement information management table includes a “time-zone” field. The “time-zone” means an area where the same standard time is used or the standard time. In the table, UTC+9 indicates a time-zone where the standard time is nine hours behind the UTC (Coordinated Universal Time).

When the time-zone is registered in the arrangement information management table, the name overlaying unit 23 incorporate a local time based on the time-zone with the name in the image data or the display data. For example, when the local time at Location A, Japan is seventeen o'clock (17:00), the local time at Location I, USA is eight o'clock (8:00).

Since the name and the local time are displayed, as shown in FIG. 29B, the user can take into account of the time-zone at the location of the participant in the conference. Meanwhile, the arrangement information management table may include arbitrary information, such as a main religion or a cultural feature at the location.

As described above, in the transmission system according to the present embodiment, a name of a transmission terminal for a video conference can be arbitrarily set by a user of each terminal.

Meanwhile, the relay apparatus 30, the transmission management apparatus 50, the transmission terminal management system 80, the program provisioning apparatus 90 and the maintenance apparatus 100 according to the present embodiment may be configured by a single computer, or may be configured by plural computers to which the respective parts (function or means) are divided and arbitrarily allocated to.

Moreover, in the case where the program provisioning apparatus 90 is configured by a single computer, a program to be sent by the program provisioning apparatus 90 may be divided into plural modules and sent or may be sent without dividing.

Furthermore, in the case where the program provisioning apparatus 90 is configured by plural computers, the program may be divided into plural modules, which are sent from the respective computers.

Moreover, a recording medium storing the program for the terminal, the program for the relay apparatus, the program for the transmission management, or the program for transmission terminal management system, the HD 204 storing the above programs, and a program provisioning apparatus 90 including the HD 204 are used as program products when the program for the terminal, the program for the relay apparatus, the program for transmission management and the program for the transmission terminal management system are provided to a domestic user, a foreign user or the like.

(Supplement to Embodiment)

In the explanation in the above embodiment, a video conference system is explained as an example of the transmission system 1 as shown in FIG. 1. However, the transmission system 1 may be a telephony system such as an IP (internet protocol) phone or an Internet phone.

Moreover, the transmission system 1, may be a communication system for a mobile phone, such as a smart phone. In this case, the transmission terminal 10 corresponds to a mobile phone. In the case where the transmission terminal 10 is a mobile phone, the transmission terminal 10 includes a main body of the mobile phone, a display button provided on the main body, a display unit (a touch panel) provided on the main body, a microphone provided in the main body, a speaker provided in the main body, and the like. In this case, the transmission terminal 10 is connected to the Internet, for example, via a mobile phone line, including wireless communication covering a relatively wide area, such as mainly an outdoor area, according to an aerial electric power from a base station.

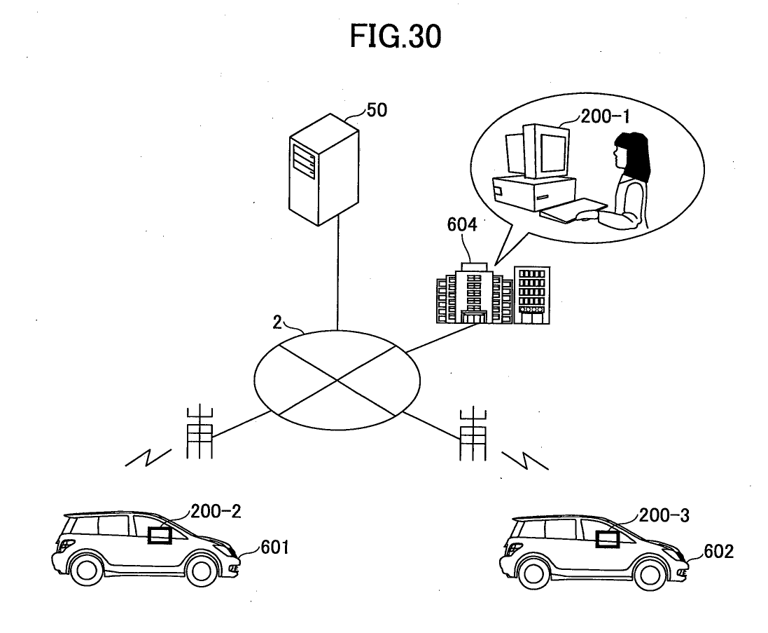

Moreover, the transmission system 1 may be a system including a car navigation apparatus installed on a moving body. FIG. 30 is a diagram illustrating an example of a system configuration in the case where the transmission terminal 10 is applied to a car navigation apparatus 200. In the following, in the case of distinguishing the car navigation apparatus 200, a reference numeral of the car navigation apparatus 200 will be denoted by 200-i, where i is a positive integer.

In this case, one transmission terminal 10 corresponds to a car navigation apparatus 200-2 installed on a car 601. The other terminal 10 corresponds to a management terminal 200-1 used by communicator in a management center 604, or a car navigation apparatus 200-3 installed on an other car 602. The management terminal 200-1, the car navigation apparatus 200-2 and the car navigation apparatus 200-3 are connected to each other via a communication network 2. Moreover, the management apparatus 200-1, the car navigation apparatus 200-2 and the car navigation apparatus 200-3 establish sessions according to the transmission management apparatus 50.

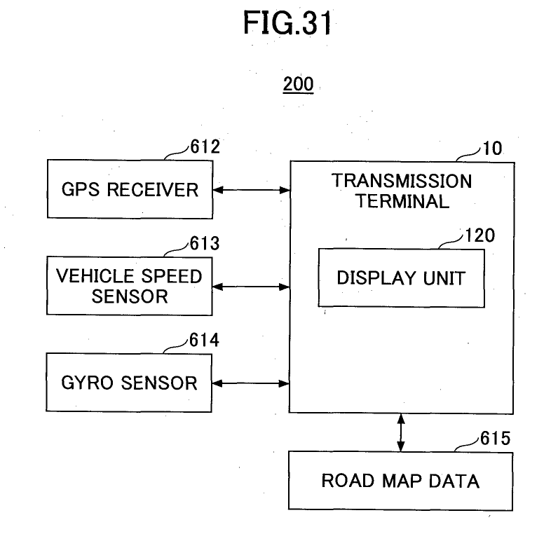

FIG. 31 is a diagram illustrating an example of a configuration of the car navigation apparatus. The car navigation apparatus 200 includes a mode in which a GPS (global positioning system) receiver 612, a vehicle speed sensor 613, a gyro sensor 614 and a road map data 615 are connected to the transmission terminal 10 as described above. Moreover, the transmission terminal 10 includes an integrated display unit 120. Meanwhile, the display unit 120 may be connected wired or wirelessly to the transmission terminal 10, or may be detachable from the transmission terminal 10.

The transmission terminal 10 provides a function of the car navigation apparatus 200 by executing a program. The GPS receiver 612 acquires a GPC satellite and outputs a coordinate of the present position. The vehicle speed sensor 613 is a sensor that detects a velocity of the car 601 or 602 (a rotational velocity of a wheel). The gyro sensor is a sensor that detects an angular velocity. A direction of travel of the car can be detected by integrating the angular velocity.

The road map data 615 are data expressing roads with a combination of nodes and links. The road map data 615 may be downloaded from an outside source or may be possessed by the car in advance. A road map is displayed on the display unit 120.

Meanwhile, a PC for sharing the screen may be connected to the transmission terminal 10. Moreover, the car navigation apparatus 200 may include, other than the configuration shown in FIG. 31, a tuner function for receiving a radio broadcast or a television broadcast, an audio function for reproducing music, a coordinating function for coordinating with a car mounted camera such as a rear view camera, a browsing function for displaying a Web site, or the like.

The transmission terminal 10 estimates the present position of the own car using the autonomous navigation by accumulating travel distances detected by the vehicle speed sensor 613 in the travel direction detected by the gyro sensor 614 beginning at the positional information detected by the GPS receiver 612. The own car position is displayed by an own car mark or the like on the road map. Moreover, a path to a destination is searched and guides a driver. In this way, the transmission terminal 10 realizes the function of the car navigation.

The car navigation 200 is connected to the communication network 2 by the transmission terminal 10. The car navigation 200 is connected to the Internet, for example, by using a mobile phone via a mobile phone line, including a wireless communication covering a relatively wide area, such as mainly an outdoor area, according to an aerial electric power from a base station.

The transmission terminal 10 as the car navigation apparatus 200 displays on the display unit 120 a list of destination terminals including other terminals 10 connected to the communication network 2. From the list of the destination terminals displayed on the display unit 120, a destination terminal is selected. When a session with the selected destination terminal is established, the transmission terminal 10 (or the car navigation apparatus) can send image data, display data or the like to the selected destination terminal or can receive image data, display data or the like from the selected destination terminal.

Moreover, by operating the car navigation apparatus 200 or the transmission terminal 10 by the user, the transmission terminal 10 can import display data such as the road map, a video picture or the like. The transmission terminal 10 can send the display data to other terminals 10 connected to the communication network 2.

Moreover, when the user selects the management terminal 200-1 used by the communicator in the management center 604 from the list of the destination terminals displayed on the display unit 120, image data of the communicator are displayed on the display unit 120 and a voice is output from the speaker. Accordingly, the user can talk with the communicator as if they communicate using a TV telephone.

As described above, the transmission terminal 10 as a car navigation apparatus 200 installed on a moving body sends/receives image data, voice data, display data and the like in the same way as the transmission terminal 10 in the video conference system. Accordingly, the transmission system 1 according to the present embodiment may be a system included in a car navigation apparatus 200 installed on the moving body.

Moreover, in the above embodiment, the video conference by using the transmission system 1 is explained. However, the present invention is not limited to this. The transmission system 1 according to the present embodiment may be used for a meeting, a general conversation in a family, between friends or the like, or a unidirectional presentation of information.

The present invention is described as the transmission terminal, the transmission system, the display method and program, with the above embodiments. The present invention is not limited to the specifically disclosed embodiments, but various variations and modifications may be made without departing from the scope of the present invention.

The present application is based on and claims the benefit of priorities of Japanese Priority Applications No. 2013-120187 filed on Jun. 6, 2013 and Japanese Priority Application No. 2014-078006 filed on Apr. 4, 2014 with the Japanese Patent Office, the entire contents of which are hereby incorporated by reference.

### DESCRIPTION OF THE REFERENCE NUMERALS

1 transmission system
2 communication network
2a,2b,2c,2d LAN
10,10aa,10ba,10db transmission terminal
11,31,41,51 transmission/reception unit
12 operation input reception unit
13 login request unit
14a image unit
14b image display control unit
14c display image acquisition unit
15a voice input unit
15b voice output unit
17 display image determination unit
18 external information transmission/reception unit
19 storage/readout process unit
21 name acquisition unit
22 arrangement information management table update unit
23 name overlaying unit
30,30a,30b,30c,30d relay apparatus
32 status detection unit
33 data quality verification unit
34 change quality management unit
35 data quality change unit
39 storage/readout process unit
40,40aa external input device
42 connection detection unit
43a installation determination unit
43b program acquisition unit
46 operation input reception unit
47 display control unit
48 mount unit
49 storage/readout process unit
50 transmission management apparatus
52 terminal authentication unit
53 status management unit
54 terminal extraction unit
55 terminal status acquisition unit
57 session management unit
58 quality determination unit
59 storage/readout process unit
60 delay time management unit
70,70a,70b,70c,70d,70e,70f router
80 transmission terminal management system
90 program provisioning apparatus
100 maintenance apparatus
101,201 CPU
102,202 ROM
103,203 RAM
104 flash memory
105 SSD
106,206 recording medium
107,207 media drive
108 operation button
109 power switch
110,210 bus line
111,209 network I/F
112 camera
113 image element I/F
114 microphone
115 speaker
116 voice input/output I/F
117 display I/F
118,215 external device I/F
119 alarm lamp
120,120aa,216 display unit
200,200-2,200-3 car navigation apparatus
200-1 management apparatus
204 HD
205 HDD
208 display I/F
211 keyboard
212 mouse
213 CD-ROM
214 CD-ROM drive
301 shared setting reception button
451 display data acquisition unit
452 display data transmission unit
601,602 car
604 management center
612 GPS receiver
613 vehicle speed sensor
614 gyro sensor
615 road map data
1000,3000,4000,5000 storage unit
1451 program for external input device
1452 arrangement information management table
3001 change quality management DB
3002 conference image management DB
5001 relay apparatus management DB
5002 terminal authentication management DB
5003 terminal management DB
5004 destination list management DB
5005 session management DB
5007 quality management DB
5008 name management DB

1. A transmission terminal for a communications connection with an other terminal via a network comprising:
a reception unit that receives display data to be displayed on a display unit connected to the transmission terminal from the other terminal;
a name acquisition unit that acquires a name associated with the other terminal from one or more names that are registered for the transmission terminal in advance;
a name overlaying unit that generates overlaid display data by incorporating the acquired name in the display data; and
an image display control unit that displays the overlaid display data on the display unit.

2. The transmission terminal as claimed in claim 1, wherein the name acquisition unit acquires a name associated with the other terminal from a name database for the transmission terminal.

3. The transmission terminal as claimed in claim 2, further comprising:
a table generation unit that generates a region management table for managing a plurality of regions on the display unit, wherein
the reception unit receives a plurality of display data from the other terminal,
the plurality of display data from the other terminal are displayed in a plurality of regions respectively, and
when the reception unit further receives data identification information for the display data and terminal identification information from the other terminal, the data identification information and the terminal identification information associated with identification information of the region in which the display data are displayed are registered in the region management table, and a name corresponding to the terminal identification information associated with the identification information of the region is registered in the region management table.

4. The transmission terminal as claimed in claim 3, wherein
the name acquisition unit acquires from the region management table a name associated with the data identification information, and
the name overlaying unit incorporates the acquired name in the display data with the data identification information.

5. The transmission terminal as claimed in claim 3, further comprising:
a display image determination unit that, when the reception unit receives the display data from the plurality of other terminals, determines the display data to be displayed and a correspondence between the display data and the display region based on a predetermined rule.

6. The transmission terminal as claimed in claim 5, wherein
the image display control unit determines a screen layout based on a display mode and a number of other terminals, an operation reception unit receiving a setting of the display mode, and
when the screen layout is changed, the name acquisition unit acquires from the region management table a name associated with data identification information and the name overlaying unit incorporates the acquired name in the display data with the data identification information.

7. The transmission terminal as claimed in claim 5, wherein
the reception unit receives from an information processing apparatus at least a part of the name database, and
the table generation unit generates the region management table using a name corresponding to terminal identification information of the other terminal from a part of the name database, or the table generation unit, after receiving the name database, acquires a name corresponding to the terminal identification information and generates the region management table.

8. (canceled)

9. A display method of displaying display data by a transmission terminal for a communications connection with an other terminal via a network, the method comprising:
receiving display data to be displayed on a display unit connected to the transmission terminal from the other terminal;
acquiring a name associated with the other terminal from one or more names that are registered for the transmission terminal in advance;
generating overlaid display data by incorporating the acquired name in the display data; and
displaying the overlaid display data on the display unit.

10. A transmission system comprising an information processing apparatus and a plurality of transmission terminals for a communications connection with the information processing apparatus via a network, wherein
in the information processing apparatus, one or more names for the transmission terminals are registered in advance, and
the transmission terminal includes:
a reception unit that receives display data to be displayed on a display unit connected to the transmission terminal from an other terminal;
a name acquisition unit that acquires a name associated with the other terminal from the information processing apparatus;
a name overlaying unit that generates overlaid display data by incorporating the acquired name in the display data; and
an image display control unit that displays the overlaid display data on the display unit.

11. A non-transitory computer-readable storage medium storing a program for causing a computer to perform the display method as claimed in claim 9.
